(19) United States
(12) Patent Application Publication
(10) Pub. No.: US 2021/0380824 A1
(43) Pub. Date: Dec. 9, 2021

(54) THERMOSENSITIVE RECORDING MEDIUM AND IMAGE FORMING METHOD

(71) Applicant: CANON KABUSHIKI KAISHA, Tokyo (JP)

(72) Inventors: Yutaka Yoshimasa, Kanagawa (JP); Junji Ito, Kanagawa (JP); Yasuhiro Aichi, Tokyo (JP); Ayano Mashida, Kanagawa (JP); Akihiro Taya, Kanagawa (JP); Masanobu Ootsuka, Tokyo (JP)

(21) Appl. No.: 17/408,574

(22) Filed: Aug. 23, 2021

Related U.S. Application Data
(63) Continuation of application No. PCT/JP2020/007980, filed on Feb. 27, 2020.

(30) Foreign Application Priority Data
Feb. 28, 2019 (JP) 2019-035533

(51) Int. Cl. C09D 11/037; C09D 11/101; C09D 11/107; B41J 2/32; B41M 5/46

(52) U.S. Cl. CPC C09D 11/037; C09D 11/101; B41M 5/46; B41J 2/32; C09D 11/107

(57) ABSTRACT

Provided is a thermosensitive recording medium including a thermosensitive coloring layer containing an electron-donating dye precursor, an electron-accepting compound, a radical polymerizable compound and a photoradical polymerization initiator, in which the radical polymerizable compound is a compound that is solid at 25° C., and the radical polymerizable compound is contained in the thermosensitive coloring layer in a state of encapsulating at least one of the electron-donating dye precursor and the electron-accepting compound.

### CROSS-REFERENCE TO RELATED APPLICATIONS

This application is a Continuation of International Patent Application No. PCT/JP2020/007980, filed Feb. 27, 2020, which claims the benefit of Japanese Patent Application No. 2019-035533, filed Feb. 28, 2019, both of which are hereby incorporated by reference herein in their entirety.

### BACKGROUND OF THE INVENTION

### Field of the Invention

The present invention relates to a thermosensitive recording medium and an image forming method using the same.

### Description of the Related Art

Conventionally, a thermosensitive recording medium using a mechanism of reacting a leuco dye with a color developer to develop a color has been widely used. The thermosensitive recording medium does not require a consumable such as an ink or a toner and is relatively inexpensive, and is therefore widely used as a recording medium for a facsimile machine, a receipt and other applications. A common thermosensitive recording medium is produced by printing or coating a coating liquid-like thermosensitive coloring composition containing water on a certain support and then drying the printed or coated composition to form a thermosensitive coloring layer.

In addition, a method of irradiating an electron beam- or ultraviolet-curable thermosensitive coloring composition with an electron beam or an ultraviolet ray to form a thermosensitive coloring layer has also been studied. For example, there has been proposed a method for producing a thermosensitive recording medium, including a step in which a film formed of a thermosensitive coloring composition containing an electron-donating dye precursor, an electron-accepting compound, an electron beam- or ultraviolet-curable compound and an epoxy compound is irradiated with an electron beam or the like to form a thermosensitive coloring layer (Japanese Patent Application Laid-Open No. 2016-78445).

However, the thermosensitive recording medium produced by the method proposed in Japanese Patent Application Laid-Open No. 2016-78445 may have a phenomenon called “fogging”, in which color is unintentionally developed during storage before the formation of an image. In order to suppress such fogging, it has been proposed in Japanese Patent Application Laid-Open No. 2016-78445 that a thermosensitive coloring composition applied onto a support is irradiated with an electron beam or an ultraviolet ray to cure the thermosensitive coloring composition. However, in a case where a thermosensitive recording medium having a thermosensitive recording layer formed by curing the thermosensitive coloring composition is used, a problem that color development property of the formed image tends to decrease is likely to occur, and therefore improvement has been desired.

Accordingly, an object of the present invention is to provide a thermosensitive recording medium capable of forming an image having excellent color development property by suppressing the occurrence of defects that occur during storage before the formation of an image, such as fogging. Another object of the present invention is to provide an image forming method using the thermosensitive recording medium.

### SUMMARY OF THE INVENTION

The foregoing objects are achieved by the following present invention. That is, according to the present invention, there is provided a thermosensitive recording medium including a thermosensitive coloring layer containing an electron-donating dye precursor, an electron-accepting compound, a radical polymerizable compound and a photoradical polymerization initiator, in which the radical polymerizable compound is a compound that is solid at 25° C., and the radical polymerizable compound is contained in the thermosensitive coloring layer in a state of encapsulating at least one of the electron-donating dye precursor and the electron-accepting compound.

Further features of the present invention will become apparent from the following description of exemplary embodiments with reference to the attached drawings.

### BRIEF DESCRIPTION OF THE DRAWINGS

FIG. 1 is a cross-sectional view showing an embodiment of a thermosensitive recording medium of the present invention.

FIG. 2 is a cross-sectional view showing another embodiment of the thermosensitive recording medium of the present invention.

### DESCRIPTION OF THE EMBODIMENTS

<Thermosensitive Recording Medium>

Hereinafter, the details of the present invention will be described with reference to preferred embodiments, but the present invention is not limited to the following embodiments. The thermosensitive recording medium of the present invention is a thermosensitive recording medium including a thermosensitive coloring layer containing an electron-donating dye precursor, an electron-accepting compound, a radical polymerizable compound and a photoradical polymerization initiator. The radical polymerizable compound is a compound that is solid at 25° C. The radical polymerizable compound is contained in the thermosensitive coloring layer in a state of encapsulating at least one of the electron-donating dye precursor and the electron-accepting compound.

In a case where the thermosensitive recording medium is stored under temperature conditions near room temperature (25° C.), at least one of the electron-donating dye precursor and the electron-accepting compound is encapsulated in the radical polymerizable compound that is a solid. For this reason, the electron-donating dye precursor and the electron-accepting compound are in a state of being difficult to come into contact with each other, which makes it possible to suppress the occurrence of defects such as fogging during storage. The “encapsulating” in the present invention does not need to completely enclose the entire electron-donating dye precursor or electron-accepting compound inside the radical polymerizable compound, and also includes the case where a part of the electron-donating dye precursor or electron-accepting compound is exposed to the outside of the radical polymerizable compound. In order to further suppress the contact between the electron-donating dye precursor and the electron-accepting compound, it is preferable that at least one of the electron-donating dye precursor and the electron-accepting compound is enclosed in a state where it is not exposed to the outside of the radical polymerizable compound.

On the other hand, in a case where heat is applied during the formation of an image, the radical polymerizable compound melts and therefore the encapsulated electron-donating dye precursor or electron-accepting compound can move. As a result, the chances of contact between the electron-donating dye precursor and the electron-accepting compound are increased, and the color can be efficiently developed to form an image.

Further, upon irradiation with an electron beam or an ultraviolet ray after the formation of an image by heating, the photoradical polymerization initiator contained in the thermosensitive coloring layer is decomposed to generate radicals. Then, it is considered that a cross-linking reaction of the radical polymerizable compound proceeds by the generated radicals and the thermosensitive coloring layer is fixed, consequently the color development property of the image is maintained for a long period of time.

(Electron-Donating Dye Precursor)

The thermosensitive coloring layer contains an electron-donating dye precursor (leuco dye). The electron-donating dye precursor is usually colorless or pale in color. The electron-donating dye precursor has a property of donating an electron or accepting a proton such as an acid to develop color. Specific examples of the electron-donating dye precursor are listed below.

Examples of the electron-donating dye precursor that develops a red or vermilion color tone include 3,6-bis(diethylamino)fluoran-γ-anilinolactam, 3,6-bis(diethylamino)fluoran-γ-(p-nitro)anilinolactam, 3,6-bis(diethylamino)fluoran-γ-(o-chloro)anilinolactam, 3-dimethylamino-7-bromofluoran, 3-diethylaminofluoran, 3-diethylamino-6-methylfluoran, 3-diethylamino-7-methylfluoran, 3-diethylamino-7-chlorofluoran, 3-diethylamino-7-bromofluoran, 3-diethylamino-7,8-benzofluoran, 3-diethylamino-6,8-dimethylfluoran, 3-diethylamino-6-methyl-7-chlorofluoran, 3-diethylamino-7-tert-butylfluoran, 3-(N-ethyl-N-tolylamino)-7-ethylfluoran and 3-(N-ethyl-N-isobutylamino)-6-methyl-7-chlorofluoran.

Further examples of the electron-donating dye precursor that develops a red or vermilion color tone include 3-cyclohexylamino-6-chlorofluoran, 3-di(n-butyl)amino-6-methyl-7-bromofluoran, 3-di(n-butyl)amino-7,8-benzofluoran, 3-tolylamino-7-methylfluoran, 3-tolylamino-7-ethylfluoran, 2-(N-acetylanilino)-3-methyl-6-di(n-butyl)aminofluoran, 2-(N-propionylanilino)-3-methyl-6-di(n-butyl)aminofluoran, 2-(N-benzoylanilino)-3-methyl-6-di(n-butyl)aminofluoran, 2-(N-carbobutoxyanilino)-3-methyl-6-di(n-butyl)aminofluoran, 2-(N-formylanilino)-3-methyl-6-di(n-butyl)aminofluoran, 2-(N-benzylanilino)-3-methyl-6-di(n-butyl)aminofluoran, 2-(N-allylanilino)-3-methyl-6-di(n-butyl)aminofluoran, 2-(N-methylanilino)-3-methyl-6-di(n-butyl)aminofluoran, 3-diethylamino-7-phenoxyfluoran and 2-methyl-6-(N-p-tolyl-N-ethylamino)-fluoran.

Examples of the electron-donating dye precursor that develops a magenta color tone include 3,3-bis(1-ethyl-2-methylindol-3-yl)phthalide, 3,3-bis(1-n-octyl-2-methylindol-3-yl)phthalide, 7-(N-ethyl-N-isoamylamino)-3-methyl-1-phenyl spiro[(1,4-dihydrochromeno[2,3-c]pyrazole)-4,3′-phthalide], 7-(N-ethyl-N-isoamylamino)-3-methyl-1-p-methylphenyl spiro[(1,4-dihydrochromeno[2,3-c]pyrazole)-4,3′-phthalide] and 7-(N-ethyl-N-n-hexylamino)-3-methyl-1-phenyl spiro[(1,4-dihydrochromeno[2,3-c]pyrazole)-4,3′-phthalide].

Further examples of the electron-donating dye precursor that develops a magenta color tone include 3-(N-ethyl-N-isoamylamino)-7,8-benzofluoran, 3,3-bis(1-n-butyl-2-methylindol-3-yl)phthalide and 3-(N-ethyl-N-isoamylamino)-7-phenoxyfluoran.

As the electron-donating dye precursor that develops a red, vermilion, or magenta color tone, it is preferable to use at least one selected from the group consisting of 3-diethylamino-7-chlorofluoran, 3-diethylamino-6,8-dimethylfluoran, 3-(N-ethyl-N-isoamylamino)-7,8-benzofluoran, 2-methyl-6-(N-p-tolyl-N-ethylamino)-fluoran, 3-di(n-butyl)amino-6-methyl-7-bromofluoran and 3,3-bis(1-n-butyl-2-methylindol-3-yl)phthalide.

Examples of the electron-donating dye precursor that develops a blue color tone include 3,3-bis(p-dimethylaminophenyl)-6-dimethylaminophthalide, 3-(4-diethylamino-2-methylphenyl)-3-(4-dimethylaminophenyl)-6-dimethylaminophthalide, 3-(4-diethylamino-2-ethoxyphenyl)-3-(1-ethyl-2-methylindol-3-yl)-4-azaphthalide, 3-(1-ethyl-2-methylindol-3-yl)-3-(4-diethylaminophenyl)phthalide, 3-(1-ethyl-2-methylindol-3-yl)-3-(2-methyl-4-diethylaminophenyl)-4-azaphthalide, 3-(1-ethyl-2-methylindol-3-yl)-3-(2-ethoxy-4-diethylaminophenyl)-4-azaphthalide, 3-(1-ethyl-2-methylindol-3-yl)-3-(2-n-hexyloxy-4-diethylaminophenyl)-4-azaphthalide and 3-diphenylamino-6-diphenylaminofluoran.

Examples of the electron-donating dye precursor that develops a cyan color tone include 3-(1-ethyl-2-methylindol-3-yl)-3-(4-diethylamino-2-methylphenyl)-4-azaphthalide, 3-[1,1-bis(p-diethylaminophenyl)ethylen-2-yl]-6-dimethylaminophthalide, 3,3-bis(4-diethylamino-2-ethoxyphenyl)-4-azaphthalide and 3,3′-bis(4-diethylamino-2-ethoxyphenyl)-4-azaphthalide.

As the electron-donating dye precursor that develops a blue or cyan color tone, it is preferable to use at least one selected from the group consisting of 3,3-bis(p-dimethylaminophenyl)-6-dimethylaminophthalide, 3-(4-diethylamino-2-methylphenyl)-3-(4-dimethylaminophenyl)-6-dimethylaminophthalide, 3-(4-diethylamino-2-ethoxyphenyl)-3-(1-ethyl-2-methylindol-3-yl)-4-azaphthalide, 3-(1-ethyl-2-methylindol-3-yl)-3-(4-diethylamino-2-methylphenyl)-4-azaphthalide, 3-(1-ethyl-2-methylindol-3-yl)-3-(2-n-hexyloxy-4-diethylaminophenyl)-4-azaphthalide, 3-[1,1-bis(p-diethylaminophenyl) ethylen-2-yl]-6-dimethylaminophthalide and 3,3′-bis(4-diethylamino-2-ethoxyphenyl)-4-azaphthalide.

Examples of the electron-donating dye precursor that develops a yellow color tone include 4-[2-[2-(butoxy)phenyl]-6-phenyl-4-pyridinyl]-N,N-dimethylbenzeneamine, 4-[2-[2-(octyloxy)phenyl]-6-phenyl-4-pyridinyl]-N,N-dimethylbenzeneamine, 4-[2-[2-(ethoxy)phenyl]-6-phenyl-4-pyridinyl]-N,N-dimethylbenzeneamine, 4-[2,6-bis(2-ethoxyphenyl)-4-pyridinyl]-N,N-dimethylbenzeneamine, 4-(2,6-diphenyl-4-pyridinyl)-N,N-dimethylbenzeneamine, 4-[2,6-bis(2-butoxyphenyl)-4-pyridinyl]-N,N-dimethylbenzeneamine, 4-[2,6-bis(2-octyloxyphenyl)-4-pyridinyl]-N,N-dimethylbenzeneamine, 4-[2-[2-(hexyloxy)phenyl]-6-phenyl-4-pyridinyl]-N,N-dimethylbenzeneamine, 4-[2,6-bis(2-hexyloxyphenyl)-4-pyridinyl]-N,N-dimethylbenzeneamine, 3,6-dimethoxyfluoran and 1-(4-n-dodecyloxy-3-methoxyphenyl)-2-(2-quinolyl)ethylene.

As the electron-donating dye precursor that develops a yellow color tone, it is preferable to use at least one selected from the group consisting of 4-[2-[2-(octyloxy)phenyl]-6-phenyl-4-pyridinyl]-N,N-dimethylbenzeneamine, 3,6-dimethoxyfluoran and 1-(4-n-dodecyloxy-3-methoxyphenyl)-2-(2-quinolyl)ethylene.

Examples of the electron-donating dye precursor that develops a green color tone include 3-(N-ethyl-N-n-hexylamino)-7-anilinofluoran, 3-diethylamino-7-dibenzylaminofluoran, 3-pyrrolidino-7-dibenzylaminofluoran, 3,3-bis(4-diethylamino-2-ethoxyphenyl)-4-azaphthalide, 3-(N-ethyl-N-p-tolylamino)-7-(N-phenyl-N-methylamino)fluoran, 3-[p-(p-anilinoanilino)anilino]-6-methyl-7-chlorofluoran and 3,6-bis(dimethylamino)fluorene-9-spiro-3′-(6′-dimethylamino)phthalide.

As the electron-donating dye precursor that develops a green color tone, it is preferable to use at least one selected from the group consisting of 3-diethylamino-7-dibenzylaminofluoran and 3-pyrrolidino-7-dibenzylaminofluoran.

Examples of the electron-donating dye precursor that develops a black color tone include 3-pyrrolidino-6-methyl-7-anilinofluoran, 3-diethylamino-7-(m-trifluoromethylanilino)fluoran, 3-diethylamino-6-methyl-7-(m-methylanilino)fluoran, 3-(N-isoamyl-N-ethylamino)-7-(o-chloroanilino)fluoran, 3-(N-ethyl-p-toluidino))-6-methyl-7-anilinofluoran, 3-(N-ethyl-N-2-tetrahydrofurfurylamino)-6-methyl-7-anilinofluoran, 3-diethylamino-6-chloro-7-anilinofluoran, 3-di(n-butyl)amino-6-methyl-7-anilinofluoran, 3-di(n-amyl)amino-6-methyl-7-anilinofluoran, 3-(N-isoamyl-N-ethylamino)-6-methyl-7-anilinofluoran, 3-(N-n-hexyl-N-ethylamino)-6-methyl-7-anilinofluoran, 3-[N-(3-ethoxypropyl)-N-ethylamino]-6-methyl-7-anilinofluoran, 3-[N-(3-ethoxypropyl)-N-methylamino]-6-methyl-7-anilinofluoran, 3-diethylamino-7-(2-chloroanilino)fluoran, 3-di(n-butyl)amino-7-(2-chloroanilino)fluoran, 3-diethylamino-6-methyl-7-anilinofluoran, 3-diethylamino-6-methyl-7-(2,6-dimethylanilino)fluoran, 3-diethylamino-6-methyl-7-(2,4-dimethylanilino)fluoran, 2,4-dimethyl-6-(4-dimethylaminoanilino)fluoran and 3-(N-cyclohexyl-N-methylamino)-6-methyl-7-anilinofluoran.

As the electron-donating dye precursor that develops a black color tone, it is preferable to use at least one selected from the group consisting of 3-di(n-butyl)amino-6-methyl-7-anilinofluoran, 3-di(n-amyl)amino-6-methyl-7-anilinofluoran, 3-diethylamino-6-methyl-7-(2,6-dimethylanilino)fluoran, 3-diethylamino-6-methyl-7-(2,4-dimethylanilino)fluoran and 2,4-dimethyl-6-(4-dimethylaminoanilino)fluoran, which have relatively excellent light resistance.

Examples of the electron-donating dye precursor having absorption in the near-infrared region include 3,3-bis[1,1-bis(4-pyrrolidinophenyl)ethylen-2-yl]-4,5,6,7-tetrabromophthalide, 3,3-bis[1-(4-methoxyphenyl)-1-(4-dimethylaminophenyl)ethylen-2-yl]-4,5,6,7-tetrachlorophthalide, 3,3-bis[1-(4-methoxyphenyl)-1-(4-pyrrolidinophenyl)ethylen-2-yl]-4,5,6,7-tetrachlorophthalide, 3-[p-(p-anilinoanilino)anilino]-6-methyl-7-chlorofluoran, 3-[p-(p-dimethylaminoanilino)anilino]-6-methyl-7-chlorofluoran, 3,6-bis(dimethylamino)fluorene-9-spiro-3′-(6′-dimethylamino)phthalide, bis(p-dimethylaminostyryl)-p-tolylsulfonylmethane, 3-[p-(p-dimethylaminoanilino)anilino]-6-methylfluoran, 3-di(n-pentyl)amino-6,8,8-trimethyl-8,9-dihydro-(3,2,e)pyridofluoran, 3-di(n-butyl)amino-6,8,8-trimethyl-8,9-dihydro-(3,2, e)pyridofluoran, 3-(p-n-butylaminoanilino)-6-methyl-7-chlorofluoran and 2-mesidino-8-diethylamino-benz[C]fluoran.

The electron-donating dye precursor is preferably contained in the thermosensitive coloring layer in a state of being encapsulated in a particle composed of a radical polymerizable compound and a photoradical polymerization initiator. In a case where the content of the electron-donating dye precursor in the thermosensitive coloring layer is 0.01 g/m² or more to 2.00 g/m² or less, an image having a more sufficient optical density can be formed, which is thus preferable.

(Electron-Accepting Compound)

The thermosensitive coloring layer contains an electron-accepting compound (color developer) having a property of developing a color of an electron-donating dye precursor upon contact. As the electron-accepting compound, it is preferable to use a compound having a property of liquefying or dissolving in a case where the temperature rises. Examples of the electron-accepting compound include organic acidic substances such as phenol compounds, aromatic carboxylic acids and polyvalent metal salts of these compounds.

Examples of the electron-accepting compound include 4-tert-butylphenol, 4-acetylphenol, 4-tert-octylphenol, 4,4′-sec-butylidenediphenol, 4-phenylphenol, 4,4′-dihydroxydiphenylmethane, 4,4′-isopropylidenediphenol, 4,4′-dihydroxydiphenyl ether, 4,4′-cyclohexylidenediphenol, 1,1-bis(4-hydroxyphenyl)ethane, 1,1-bis(4-hydroxyphenyl)-1-phenylethane, 4,4′-dihydroxydiphenylsulfide, 4,4′-thiobis(3-methyl-6-tert-butylphenol), 4,4′-dihydroxydiphenylsulfone, 2,4′-dihydroxydiphenylsulfone, 4-hydroxy-4′-isopropoxydiphenylsulfone, 4-hydroxy-4′-n-propoxydiphenylsulfone, 4-hydroxy-4′-allyloxydiphenyl sulfone, bis(3-allyl-4-hydroxyphenyl)sulfone, 4,4′-bis[(4-methyl-3-phenoxycarbonylaminophenyl)ureido]diphenyl sulfone, 4-[4′-(1′-methylethyloxy)phenyl]sulfonylphenol, N-(p-toluenesulfonyl)-N′-(3-p-toluenesulfonyl oxyphenyl)urea, N-p-tolyl sulfonyl-p-butoxycarbonylphenylurea, N-(p-toluenesulfonyl)-N′-phenylurea and 4,4′-bis(3-tosylureido)diphenylmethane.

Further examples of the electron-accepting compound include organic acidic substances, for example, phenol compounds such as 4-hydroxybenzophenone, dimethyl 4-hydroxyphthalate, methyl 4-hydroxybenzoate, propyl 4-hydroxybenzoate, sec-butyl 4-hydroxybenzoate, phenyl 4-hydroxybenzoate, benzyl 4-hydroxybenzoate, tolyl 4-hydroxybenzoate, chlorophenyl 4-hydroxybenzoate and 4,4′-dihydroxydiphenyl ether; aromatic carboxylic acids such as benzoic acid, p-tert-butylbenzoic acid, trichlorbenzoic acid, terephthalic acid, salicylic acid, 3-tert-butylsalicylic acid, 3-isopropylsalicylic acid, 3-benzylsalicylic acid, 3,5-(α-methylbenzyl)salicylic acid and 3,5-di-tert-butylsalicylic acid; and salts of these compounds with polyvalent metals such as zinc, magnesium, aluminum and calcium.

The electron-accepting compound is preferably contained in the thermosensitive coloring layer in a state of being encapsulated in a particle composed of a radical polymerizable compound and a photoradical polymerization initiator. In a case where the content of the electron-accepting compound in the thermosensitive coloring layer is 0.01 g/m² or more to 10.00 g/m² or less, an image having a more sufficient optical density can be formed, which is thus preferable. In addition, the content of the electron-accepting compound in the thermosensitive coloring layer is preferably 100% by mass or more to 1,000% by mass or less with respect to the electron-donating dye precursor. In a case where the content of the electron-accepting compound with respect to the electron-donating dye precursor is set to 100% by mass or more, the color development property of an image can be further improved. On the other hand, in a case where the content of the electron-accepting compound with respect to the electron-donating dye precursor is set to 1,000% by mass or less, the deterioration of the texture due to an increase in film thickness can be suppressed and the film strength can be improved.

(Radical Polymerizable Compound)

The thermosensitive coloring layer contains a radical polymerizable compound that is solid at 25° C. That is, the melting point of the radical polymerizable compound that is solid at 25° C. is higher than 25° C.

The melting point of the radical polymerizable compound is preferably 60° C. or higher. By using a radical polymerizable compound having a melting point of 60° C. or higher, it is possible to further suppress the occurrence of fogging due to storage. In addition, the glass transition point of the radical polymerizable compound is preferably 40° C. or higher. By using a radical polymerizable compound having a glass transition point of 40° C. or higher, it is possible to further suppress fogging due to storage. Both the melting point and the glass transition point of the radical polymerizable compound can be measured by differential scanning calorimetry (DSC). The scanning speed can be set to, for example, 10° C./min.

Examples of the radical polymerizable compound that is solid at 25° C. include a radical polymerizable monomer, a radical polymerizable oligomer and a radical polymerizable polymer.

Examples of the radical polymerizable monomer that is solid at 25° C. include stearyl acrylate, behenyl acrylate, cyclohexanedimethanol diacrylate, bisphenol A diacrylate, ethoxylated bisphenol A diacrylate, propoxylated bisphenol A diacrylate, hydrogenated bisphenol A diacrylate, ethoxylated hydrogenated bisphenol A diacrylate, propoxylated hydrogenated bisphenol A diacrylate and tris(2-hydroxyethyl)isocyanurate triacrylate.

Examples of the radical polymerizable oligomer that is solid at 25° C. include oligomer compounds in which an acrylate group is bonded to an oligomer such as a urethane oligomer, an epoxy oligomer or a polyester oligomer. A suitable linking group may be interposed between the oligomer and the acrylate group.

Examples of the radical polymerizable polymer that is solid at 25° C. include polymer compounds in which an acrylate group is bonded to a polymer such as an acrylic polymer, a urethane polymer, an epoxy polymer or a polyester polymer. A suitable linking group may be interposed between the polymer and the acrylate group.

Two or more radical polymerizable compounds may be used in combination. The melting point of the radical polymerizable compound in a case where two or more radical polymerizable compounds are used is intended to mean a melting point of a mixture of radical polymerizable compounds. In addition, the glass transition point of the radical polymerizable compound in a case where two or more radical polymerizable compounds are used is intended to mean a glass transition point of a mixture of radical polymerizable compounds.

The molecular weight of the radical polymerizable compound is preferably 1,000 or more and more preferably 10,000 or more. In a case where the radical polymerizable compound having a molecular weight of 1,000 or more is used, the color development property of the image can be maintained for a longer period of time, and the storage stability of the image can be further improved. In addition, in a case where the radical polymerizable compound having a molecular weight of 1,000 or more is used, the storage stability of the image can be improved even in a case where the amount of radicals generated is reduced by reducing the amount of ultraviolet irradiation. Reducing the amount of ultraviolet irradiation makes it possible to improve the image formation speed (printing speed), which is thus preferable.

The molecular weight of the radical polymerizable compound is preferably 1,000,000 or less from the viewpoint of handleability of the coating liquid for forming the thermosensitive coloring layer. The molecular weight of the radical polymerizable compound in the present specification means a molecular weight for the radical polymerizable monomer, and a weight average molecular weight (Mw) for the radical polymerizable oligomer and the radical polymerizable polymer.

The weight average molecular weight of the radical polymerizable compound is a value in terms of polystyrene measured by size exclusion chromatography (SEC). The measurement of the weight average molecular weight by SEC can be carried out by the procedure shown below. First, a sample is added to the following eluent to make a concentration of 1.0% by mass, followed by allowing to stand at room temperature for 24 hours to prepare a specimen. Next, the specimen is filtered through a solvent-resistant membrane filter having a pore size of 0.2 and then separated according to the following conditions, whereby the weight average molecular weight of the radical polymerizable compound can be measured.
Device: high-speed GPC device “HLC-8220 GPC” (manufactured by Tosoh Corporation)
Column: two MIXED-C connected in series
Eluent: THF (sodium trifluoroacetate added)
Flow rate: 1.0 mL/min
Oven temperature: 40° C.
Specimen injection volume: 0.025 mL

In calculating the weight average molecular weight, a molecular weight calibration curve prepared using a standard polystyrene resin (manufactured by Tosoh Corporation, TSK standard polystyrene F-850, F-450, F-288, F-128, F-80, F-40, F-20, F-10, F-4, F-2, F-1, A-5000, A-2500, A-1000 or A-500) can be used.

The radical polymerizable compound is contained in the thermosensitive coloring layer in a state of encapsulating at least one of the electron-donating dye precursor and the electron-accepting compound. The form of the radical polymerizable compound in the thermosensitive coloring layer is not particularly limited. For example, the radical polymerizable compound can be in the form of a particle, a layer, or the like. The radical polymerizable compound may encapsulate both the electron-donating dye precursor and the electron-accepting compound as long as the electron-donating dye precursor and the electron-accepting compound are in a state of making it difficult for the two components to come into contact with each other. However, in order to make it more difficult for the electron-donating dye precursor and the electron-accepting compound to come into contact with each other during storage of the thermosensitive recording medium, the radical polymerizable compound is preferably contained in the thermosensitive coloring layer in a state in which the electron-donating dye precursor and the electron-accepting compound are separately encapsulated.

For example, in a case where the radical polymerizable compound is contained in the thermosensitive coloring layer in the form of a layer, the thermosensitive coloring layer preferably has a first layer containing a radical polymerizable compound encapsulating an electron-donating dye precursor and a second layer containing a radical polymerizable compound encapsulating an electron-accepting compound. Hereinafter, the first layer containing a radical polymerizable compound encapsulating an electron-donating dye precursor is also referred to as an “electron-donating dye precursor layer” or a “leuco layer”. In addition, the second layer containing a radical polymerizable compound encapsulating an electron-accepting compound is also referred to as an “electron-accepting compound layer” or a “color developer layer”.

In addition, in a case where the radical polymerizable compound is contained in the thermosensitive coloring layer in the form of a particle, the radical polymerizable compound is preferably contained in the thermosensitive coloring layer in a state of a first particle encapsulating an electron-donating dye precursor and in a state of a second particle encapsulating an electron-accepting compound. The radical polymerizable compounds that form the first particle and the second particle, respectively, may be the same or different from each other. At least one of the first particle and the second particle preferably contains a photoradical polymerization initiator which will be described later.

The particle size of the first particle is preferably 10 nm or more to 1,000 nm or less and more preferably 50 nm or more to 300 nm or less. The particle size of the second particle is preferably 10 nm or more to 1,000 nm or less and more preferably 50 nm or more to 300 nm or less. In a case where the particle sizes of the first particle and the second particle are each 10 nm or more, and further 50 nm or more, the radical polymerization reactivity becomes high and the image storage stability can be further improved. On the other hand, in a case where the particle sizes of the first particle and the second particle are each 1,000 nm or less, and further 300 nm or less, unnecessary light scattering in the thermosensitive coloring layer can be reduced and the image density can be increased. The particle size of the particle in the present specification means a 50% particle size (D50) based on the volume distribution.

(Photoradical Polymerization Initiator)

The thermosensitive coloring layer contains a photoradical polymerization initiator. The photoradical polymerization initiator may be any compound that can generate radicals by the action of light. As the photoradical polymerization initiator, various known compounds such as a radical generator, a radical polymerization initiator and a photoradical polymerization initiator can be used.

Examples of the photoradical polymerization initiator include an aromatic ketone compound, an acylphosphine oxide compound, a benzoin alkyl ether compound, a benzoin ether compound, a thioxanthone compound, a benzophenone compound, a benzoate compound, an aromatic onium salt compound, an organic peroxide, a thio compound (such as a thiophenyl group-containing compound), an α-aminoalkylphenone compound, a hexaarylbiimidazole compound, a ketooxime ester compound, a borate compound, an azinium compound, a metallocene compound, an active ester compound, a compound having a carbon-halogen bond and an alkylamine compound. In addition, radical generators described in Japanese Patent Application Laid-Open No. 2018-35369, Japanese Patent Application Laid-Open No. 2018-39265, and the like can also be used.

Of these compounds, an aromatic ketone compound, an acylphosphine oxide compound, a benzoin alkyl ether compound, a benzoin ether compound, a thioxanthone compound, a benzophenone compound and a benzoate compound are preferable. The photoradical polymerization initiators may be used alone or in combination of two or more. The content of the photoradical polymerization initiator in the thermosensitive coloring layer is preferably 0.1% by mass or more to 30% by mass or less, and more preferably 1% by mass or more to 25% by mass or less with respect to the radical polymerizable compound. In a case where the first particle and the second particle each contain a photoradical polymerization initiator, these photoradical polymerization initiators may be the same or different from each other.

Examples of the aromatic ketone compound include acetophenone, 2-hydroxy-2-methyl-1-phenyl-1-propanone, 2,2-diethoxyacetophenone, 2,2-dimethoxy-2-phenylacetophenone, 4-methylbenzophenone, 2,2′-phenyl p-tert-butyltrichloroacetophenone, p-tert-butyldichloroacetophenone, benzophenone, 4-phenylbenzophenone, methylbenzoylformate, 4-[(4-methylphenyl)thio]benzophenone, 4, 4′-bis(diethylamino)benzophenone, N,N′-tetramethyl-4,4′-diaminobenzophenone (Michler's ketone), 1-hydroxycyclohexylphenylketone, 1-[4-(2-hydroxyethoxy)-phenyl]-2-hydroxy-2-methylpropane, 2-benzyl-2-dimethylamino-1-(4-morpholinophenyl)-butanone-1,2-methyl-[4-(methylthio)phenyl]-2-morpholino-1-propane, 2-(dimethylamino)-2-[(4-methylphenyl)methyl]-1-[4-(4-morpholinyl)phenyl]-1-butanone, and 2-hydroxy-1-{4-[4-(2-hydroxy-2-methyl-propionyl)-benzyl]-phenyl}-2-methyl-propan-1-one.

Examples of the acylphosphine oxide compound include 2,4,6-trimethylbenzoyldiphenylphosphine oxide and bis(2,4,6-trimethylbenzoyl)-diphenylphosphine oxide.

Examples of the benzoin alkyl ether compound include benzoin methyl ether, benzoin ethyl ether, benzoin butyl ether, and benzoin isopropyl ether.

Examples of the benzoin ether compound include methylbenzoin and ethylbenzoin.

Examples of the thioxanthone compound include 2-chlorothioxanthone, 2,4-diethylthioxanthone, isopropylthioxanthone, and 2-methylthioxanthone.

Examples of the benzophenone compound include benzophenone, 4-methylbenzophenone, 4-phenylbenzophenone, 4-(4-methylphenylthio)benzophenone, and 4,4′-bis(diethylamino)benzophenone.

Examples of the benzoate compound include ethyl-4-(dimethylamino)-benzoate, ethylhexyl-4-dimethylaminobenzoate, methyl-o-benzoylbenzoate, and 3-methylbutyl p-(dimethylamino)benzoate.

(Other Components)

The thermosensitive coloring layer can contain a storage stability improver. The storage stability of the color-developed image can be further improved by incorporating the storage stability improver in the thermosensitive coloring layer. Examples of the storage stability improver include phenol compounds such as 1,1,3-tris(2-methyl-4-hydroxy-5-cyclohexylphenyl)butane, 1,1,3-tris(2-methyl-4-hydroxy-5-tert-butylphenyl)butane, 1,1-bis(2-methyl-4-hydroxy-5-tert-butylphenyl)butane, 4,4′-[1,4-phenylenebis(1-methylethylidene)]bisphenol, and 4,4′-[1,3-phenylenebis(1-methylethylidene)]bisphenol; epoxy compounds such as 4-benzyloxyphenyl-4′-(2-methyl-2,3-epoxypropyloxy)phenyl sulfone, 4-(2-methyl-1,2-epoxyethyl)diphenylsulfone, and 4-(2-ethyl-1,2-epoxyethyl)diphenylsulfone; and isocyanuric acid compounds such as 1,3,5-tris(2,6-dimethylbenzyl-3-hydroxy-4-tert-butyl) isocyanurate.

The thermosensitive coloring layer can contain a heat sentitizer. The recording sensitivity can be increased by incorporating the heat sentitizer in the thermosensitive coloring layer. Examples of the heat sentitizer include stearic acid amide, methoxycarbonyl-N-stearic acid benzamide, N-benzoyl stearic acid amide, N-eicosanoic acid amide, ethylenebisstearic acid amide, behenic acid amide, methylenebisstearic acid amide, N-methylol stearic acid amide, dibenzyl terephthalate, dimethyl terephthalate, dioctyl terephthalate, diphenyl sulfone, benzyl p-benzyloxybenzoate, phenyl 1-hydroxy-2-naphthoate, benzyl 2-naphthyl ether, m-terphenyl, p-benzylbiphenyl, di-p-chlorobenzyl oxalate, di-p-methylbenzyl oxalate, dibenzyl oxalate, p-tolyl biphenyl ether, di(p-methoxyphenoxyethyl)ether, 1,2-di(3-methylphenoxy)ethane, 1,2-di(4-methylphenoxy)ethane, 1,2-di(4-methoxyphenoxy)ethane, 1,2-di(4-chlorophenoxy)ethane, 1,2-diphenoxyethane, 1-(4-methoxyphenoxy)-2-(3-methylphenoxy)ethane, p-methylthiophenylbenzylether, 1,4-di(phenylthio)butane, p-acetotoluidide, p-acetophenetidide, N-acetoacetyl-p-toluidine, 1,2-diphenoxymethylbenzene, di(β-biphenylethoxy)benzene, p-di(vinyloxyethoxy)benzene, 1-isopropylphenyl-2-phenylethane, di-o-chlorobenzyl adipate, 1,2-bis(3,4-dimethylphenyl)ethane, 1,3-bis(2-naphthoxy)propane, diphenyl and benzophenone. The content of the heat sentitizer in the thermosensitive coloring layer may be an amount effective for thermosensitization. Specifically, the content of the heat sentitizer is preferably 2% by mass or more to 40% by mass or less, and preferably 5% by mass or more to 25% by mass or less based on the total solid content of the thermosensitive coloring layer.

An aid such as a storage stability improver or a heat sentitizer may be mixed with a coating liquid for forming a thermosensitive coloring layer in a state of fine particles (solid dispersed fine particles) dispersed in water. In addition, these aids can be dissolved in a solvent and emulsified using a water-soluble polymer compound as an emulsifier, for being used in an emulsified state. Further, the storage stability improver and the heat sentitizer may be contained in the particle containing the electron-donating dye precursor and the electron-accepting compound.

The thermosensitive coloring layer can contain a polymerization accelerator. Examples of the polymerization accelerator include a benzoate compound and an amine compound.

Examples of the benzoate compound include ethyl-4-(dimethylamino)-benzoate, ethylhexyl-4-dimethylaminobenzoate, methyl-o-benzoylbenzoate, 3-methylbutyl p-(dimethylamino)benzoate, ethyl N,N-dimethylaminobenzoate, isoamyl N,N-dimethylaminobenzoate, pentyl 4-dimethylaminobenzoate, triethylamine and triethanolamine.

The thermosensitive coloring layer can contain a sensitizer. The sensitizer may be any sensitizer that sensitizes the photoradical polymerization initiator by an electron transfer mechanism or an energy transfer mechanism. Examples of the sensitizer include aromatic polycondensate compounds such as anthracene, 9,10-dialkoxyanthracene, pyrene and perylene; aromatic ketone compounds such as acetophenone, benzophenone, thioxanthone and Michler's ketone; and heterocyclic compounds such as phenothiazine and N-aryloxazolidinone. The content of the sensitizer in the thermosensitive coloring layer is preferably 0.1 parts by mass or more to 10 parts by mass or less, and more preferably 1 part by mass or more to 5 parts by mass or less with respect to 1 part by mass of the photoradical polymerization initiator.

In order to improve the electron transfer efficiency or energy transfer efficiency between the sensitizer and the photoradical polymerization initiator, it is preferable to include a sensitization aid in the thermosensitive coloring layer. Examples of the sensitization aid include naphthalene compounds such as 1,4-dihydroxynaphthalene, 1,4-dimethoxynaphthalene, 1,4-diethoxynaphthalene, 4-methoxy-1-naphthol and 4-ethoxy-1-naphthol; and benzene compounds such as 1,4-dihydroxybenzene, 1,4-dimethoxybenzene, 1,4-diethoxybenzene, 1-methoxy-4-phenol and 1-ethoxy-4-phenol. The content of the sensitization aid in the thermosensitive coloring layer is preferably 0.1 parts by mass or more to 10 parts by mass or less, and preferably 0.5 parts by mass or more to 5 parts by mass or less with respect to 1 part by mass of the sensitizer.

The thermosensitive coloring layer can contain a radical polymerization inhibitor. The photoradical polymerization initiator is slightly decomposed into a radical compound during storage of the thermosensitive recording medium. Since polymerization due to this radical compound may be triggered, it is preferable to include the radical polymerization inhibitor in the thermosensitive coloring layer in order to prevent this polymerization.

Examples of the radical polymerization inhibitor include phenolic hydroxyl group-containing compounds, quinones such as methoquinone (hydroquinone monomethyl ether), hydroquinone and 4-methoxy-1-naphthol, hindered amine antioxidants, 1,1-diphenyl-2-picrylhydrazyl free radicals, N-oxyl free radical compounds, nitrogen-containing heterocyclic mercapto compounds, thioether antioxidants, hindered phenolic antioxidants, ascorbic acids, zinc sulfates, thiocyanates, thiourea derivatives, various sugars, phosphoric acid antioxidants, nitrites, sulfites, thiosulfates, hydroxylamine derivatives, aromatic amines, phenylenediamines, imines, sulfonamides, urea derivatives, oximes, polycondensates of dicyandiamide and polyalkylene polyamine, sulfur-containing compounds such as phenothiazine, complexing agents based on tetraaza annulene (TAA), and hindered amines.

Among them, phenols, N-oxyl free radical compounds, 1,1-diphenyl-2-picrylhydrazyl free radicals, phenothiazines, quinones and hindered amines are preferable as the radical polymerization inhibitor. In addition, N-oxyl free radical compounds are more preferable. The content of the radical polymerization inhibitor in the thermosensitive coloring layer is preferably 1 ppm or more to 5,000 ppm or less on a mass basis with respect to the content of the radical polymerizable compound.

The thermosensitive coloring layer can contain a pigment having a high degree of whiteness and an average particle size of 10 μm or less. Incorporation of such a pigment makes it possible to improve the whiteness of the thermosensitive coloring layer and the uniformity of the image. Examples of the pigment include inorganic pigments such as calcium carbonate, magnesium carbonate, kaolin, clay, talc, calcined clay, silica, diatomaceous earth, synthetic aluminum silicate, zinc oxide, titanium oxide, aluminum hydroxide, barium sulfate, surface-treated calcium carbonate and silica; and organic pigments such as urea-formalin resin, styrene-methacrylic acid copolymer resin and polystyrene resin. The content of the pigment in the thermosensitive coloring layer is preferably an amount that does not reduce the color-developing density of the image. Specifically, the content of the pigment is preferably 50% by mass or less based on the total solid content of the thermosensitive coloring layer.

A binder can be used as a component for constituting the thermosensitive coloring layer. In addition, the thermosensitive coloring layer can contain, if necessary, a cross-linking agent, a wax, a metal soap, a colored dye, a colored pigment, a fluorescent dye and the like. Examples of the binder include polyvinyl alcohol and its derivatives; starch and its derivatives; cellulose derivatives such as hydroxymethyl cellulose, hydroxyethyl cellulose, hydroxypropyl cellulose, methyl cellulose and ethyl cellulose; water-soluble polymer materials such as sodium polyacrylate, polyvinylpyrrolidone, acrylamide-acrylate copolymer, acrylamide-acrylate-methacrylate copolymer, styrene-maleic anhydride copolymer, isobutylene-maleic anhydride copolymer, casein, gelatin and their derivatives; emulsions of polyvinyl acetate, polyurethane, polyacrylic acid, polyacrylic acid ester, vinyl chloride-vinyl acetate copolymer, polybutyl methacrylate, ethylene-vinyl acetate copolymer and the like; and latexes of water-insoluble polymers such as styrene-butadiene copolymer and styrene-butadiene-acrylic copolymer.

The water resistance of the thermosensitive coloring layer can be improved by incorporating a cross-linking agent in the thermosensitive coloring layer. Examples of the cross-linking agent include organic compounds, for example, aldehyde compounds such as glyoxal, polyamine compounds such as polyethyleneimine, epoxy compounds, polyamide resins, melamine resins, glyoxylates, dimethylolurea compounds, aziridine compounds and blocked isocyanate compounds; inorganic compounds such as ammonium persulfate, ferric chloride, magnesium chloride, sodium tetraborate and potassium tetraborate; boric acid, boric acid triester, boron-based polymers, hydrazide compounds. The content of the cross-linking agent in the thermosensitive coloring layer is preferably 1 part by mass or more to 10 parts by mass or less with respect to 100 parts by mass of the total solid content of the thermosensitive coloring layer.

Examples of the wax include waxes such as paraffin wax, carnauba wax, microcrystalline wax, polyolefin wax, and polyethylene wax; higher fatty acid amides such as stearic acid amide and ethylene bisstearic acid amide; and higher fatty acid esters and their derivatives. Examples of the metal soap include polyvalent metal salts of higher fatty acids such as zinc stearate, aluminum stearate, calcium stearate and zinc oleate.

In a case where the thermosensitive recording medium is a two-color thermosensitive recording medium, it is preferable that the thermosensitive coloring layer contains a colored dye or colored pigment having a color tone that is complementary to a low-temperature color-developing color tone. The color tone of the thermosensitive recording medium before and after forming an image can be adjusted by incorporating such a colored dye or colored pigment in the thermosensitive coloring layer. Further, if necessary, various aids such as an oil repellent, an antifoaming agent and a viscosity modifier can be contained in the thermosensitive coloring layer.

The thermosensitive coloring layer can be formed, for example, by using water as a dispersion medium, applying a coating liquid for the thermosensitive coloring layer containing individual components constituting the thermosensitive coloring layer onto a support to form a coating layer, and then drying the coating layer. The amount of the coating liquid to be applied is preferably 2 g/m² or more to 20 g/m² or less, more preferably 2 g/m² or more to 15 g/m² or less, and particularly preferably 2 g/m² or more to 10 g/m² or less in terms of dry mass.

It is preferable to use a surfactant to prepare the above-mentioned first particle and second particle. Examples of the surfactant include anionic surfactants such as sodium alkylsulfonate, sodium alkylbenzenesulfonate, sodium dialkylsulfosuccinate and sodium alkylcarboxylate; nonionic surfactants such as polyoxyethylene alkyl ether, polyoxyethylene alkyl ester, polyoxyethylene polyoxypropylene glycol, sorbitan alkyl ester, polyoxyethylene sorbitan alkyl ester, glycerin alkyl ester and polyoxyethylene hydrogenated castor oil; cationic surfactants such as alkyltrimethylammonium chloride, dialkyldimethylammonium chloride and alkylbenzyldimethylammonium chloride; and amphoteric surfactants such as alkylbetaine and alkyldimethylamine oxide. Further, a polymer-type surfactant such as a sodium salt of naphthalene sulfonic acid-formalin condensate or sodium polyacrylate can be used.

It is also possible to use a radical polymerizable compound in which an ionic group such as a sulfonic acid group, a carboxylic acid group or an amino group; or a hydrophilic nonionic group such as a polyoxyethylene group or a polyglyceryl group is bonded to the radical polymerizable compound to impart a surface active ability.

It is also possible to use a dispersion aid to prepare the above-mentioned first particle and second particle. Examples of the dispersion aid include water-soluble polymers such as polyvinyl alcohol and its modified products, polyacrylic acid amide and its derivatives, ethylene/vinyl acetate copolymer, styrene/maleic anhydride copolymer, ethylene/maleic anhydride copolymer, isobutylene/maleic anhydride copolymer, polyvinylpyrrolidone, ethylene/acrylic acid copolymer, vinyl acetate/acrylic acid copolymer, carboxymethyl cellulose, methyl cellulose, casein, gelatin, starch derivatives, gum arabic and sodium alginate.

The amount of the surfactant and the dispersion aid added is preferably 0.1% by mass or more to 10% by mass or less, and more preferably 0.5% by mass or more to 5% by mass or less based on the respective masses of the first particle and the second particle.

(Intermediate Layer)

In a case where the thermosensitive coloring layer has an electron-donating dye precursor layer (leuco layer) and an electron-accepting compound layer (color developer layer), an intermediate layer can be provided between these layers. As the material constituting the intermediate layer, a water-soluble polymer material or a water-insoluble polymer used in a known thermosensitive recording medium can be used. Specific examples of the material constituting the intermediate layer include the same materials as those of the binder which is a component for constituting the thermosensitive coloring layer. In addition, the intermediate layer may contain, as aids, a particle having a high porosity such as silica or calcined kaolin, a plastic pigment, a hollow particle, a foamed body, and an organic compound such as polyethylene wax having a glass transition point or melting point.

The intermediate layer can be formed, for example, by using water as a dispersion medium, applying a coating liquid for the intermediate layer containing individual components constituting the intermediate layer to form a coating layer, and then drying the coating layer. The amount of the coating liquid to be applied is preferably 1 g/m² or more to 40 g/m² or less, and more preferably 2 g/m² or more to 10 g/m² or less in terms of dry mass.

(Protective Layer)

It is preferable to have a protective layer on the thermosensitive coloring layer. As the protective layer, a protective layer used in a known thermosensitive recording medium can be used. For example, it is preferable to provide a protective layer containing a water-soluble polymer material and particles. In addition, the above-mentioned intermediate layer may be provided between the thermosensitive coloring layer and the protective layer. As the water-soluble polymer material and particles, the same materials as those that can be contained in the thermosensitive coloring layer can be used. Further, it is also preferable to add a cross-linking agent to impart water resistance to the protective layer.

The light resistance can be significantly improved by incorporating microcapsules encapsulating an ultraviolet absorber or solid dispersed fine particles of the ultraviolet absorber into the protective layer. Above all, microcapsules having a wall film made of a polyurethane-polyurea resin or an aminoaldehyde resin are preferable because they have excellent heat resistance and also exhibit excellent incidental effects such as suppressing sticking to a thermal head. In addition, the microcapsules having a wall film made of a polyurethane-polyurea resin or an aminoaldehyde resin have a lower refractive index than microcapsules having a wall film made of other resins. Furthermore, the microcapsules have a spherical shape and therefore even in a case of being added in a large amount to the protective layer, a decrease in concentration due to diffused reflection of light is unlikely to occur, which is preferable.

In addition, incorporation of particles into the protective layer is preferable because it is possible to prevent dirt from adhering to a thermal head and sticking to the thermal head. The oil absorption of the particles is preferably 50 mL/100 g or more. The content of the particles in the protective layer is preferably an amount that does not reduce the color development density, and specifically, is preferably 60% by mass or less based on the total solid content of the protective layer.

The protective layer can be formed, for example, by using water as a dispersion medium, applying a coating liquid for the protective layer containing individual components constituting the protective layer onto the thermosensitive coloring layer to form a coating layer, and then drying the coating layer. The amount of the coating liquid to be applied is preferably 0.1 g/m² or more to 15 g/m² or less, and more preferably 0.5 g/m² or more to 8 g/m² or less in terms of dry mass.

(Resin Layer)

A resin layer formed of a resin cured by an electron beam or an ultraviolet ray can be provided on the thermosensitive coloring layer, the intermediate layer and the protective layer. As the resin cured by an electron beam, for example, the resin described in Japanese Patent Application Laid-Open No. S58-177392 or the like can be used. Aids such as a non-electron beam-curable resin, a particle, a defoaming agent, a leveling agent, a lubricant, a surfactant, and a plasticizer may be appropriately added to the resin constituting the resin layer. Above all, addition of a particle such as calcium carbonate or aluminum hydroxide; or a lubricant such as waxes or silicon is preferable because sticking to a thermal head can be suppressed.

(Other Layers)

It is possible to increase the added value of the thermosensitive recording medium by processing the thermosensitive recording medium to have higher functionality. For example, the thermosensitive recording medium can be made into an adhesive paper, a remoistening adhesive paper, or a delayed-tack paper by applying an adhesive, a remoistening adhesive, or a delayed-tack adhesive to a rear surface of the thermosensitive recording medium. In addition, the thermosensitive recording medium can be made into a recording paper that allows double-sided recording, by imparting functionality of thermal transfer paper, ink jet recording paper, carbonless paper, electrostatic recording paper, xerography paper or the like to the rear surface of the thermosensitive recording medium. Furthermore, the thermosensitive recording medium can be made into a double-sided thermosensitive recording medium by arranging a thermosensitive coloring layer on the rear surface of the thermosensitive recording medium. In addition, a back layer can also be provided on the rear surface of the thermosensitive recording medium in order to prevent infiltration of the oil or plasticizer from the rear surface of the thermosensitive recording medium, or for control of curling or prevention of static charge.

(Layer Configuration of Thermosensitive Recording Medium)

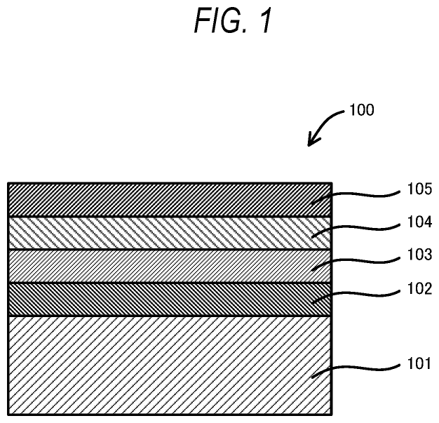

FIG. 1 is a cross-sectional view showing an embodiment of the thermosensitive recording medium of the present invention. A thermosensitive recording medium 100 shown in FIG. 1 includes a sheet-like support 101, an electron-donating dye precursor layer 102 provided on one surface side of the support 101, and an electron-accepting compound layer 104 provided on the electron-donating dye precursor layer 102. In addition, an intermediate layer 103 is provided between the electron-donating dye precursor layer 102 and the electron-accepting compound layer 104, and a protective layer 105 is provided on the electron-accepting compound layer 104. The thermosensitive recording medium according to the embodiment of the present invention may not be provided with the intermediate layer 103 and the protective layer 105 as shown in FIG. 1.

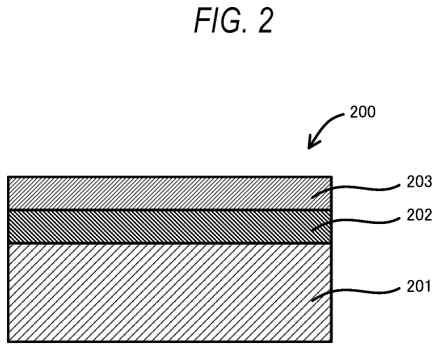

FIG. 2 is a cross-sectional view showing another embodiment of the thermosensitive recording medium of the present invention. A thermosensitive recording medium 200 shown in FIG. 2 includes a sheet-like support 201, a thermosensitive coloring layer 202 provided on one surface side of the support 201, and a protective layer 203 provided on the thermosensitive coloring layer 202. The thermosensitive recording medium according to the embodiment of the present invention may not be provided with the protective layer 203.

The support may be made of a material on which a coating film can be formed using a coating liquid (thermosensitive coloring composition) for the thermosensitive coloring layer. Examples of the constituent material of the support include paper, synthetic paper, and various plastics. Examples of the plastic include polyethylene terephthalate (PET) and oriented polypropylene (OPP). The surface of the support is preferably subjected to a corona discharge treatment, a sandblast treatment, a primer treatment (lamination of an undercoat layer), or the like, if necessary. Application of these treatments can provide improved wettability of the surface of the support, roughening of the surface and easy adhesion to the surface, which makes it possible to enhance the formability of a coating film by the thermosensitive coloring composition.

The coating film can be formed by applying or printing the thermosensitive coloring composition on the support. Examples of the device for applying or printing the thermosensitive coloring composition include a blade coater, a rod coater, a reverse roll coater, a die coater, an offset printing machine, a gravure printing machine, a flexographic printing machine, a letterpress printing machine and a silk screen printing machine. The intermediate layer or the protective layer can be formed using an intermediate layer composition or an overcoat composition which is prepared by the same method as the method for preparing the thermosensitive coloring composition. A coating film can be formed by applying such an intermediate layer composition or overcoat composition onto a predetermined portion. Each layer can be formed by forming each coating film and then drying the formed coating film to obtain a desired thermosensitive recording medium. The coating film may be applied and dried layer by layer, or the same coating liquid may be applied and dried in two or more times. Further, simultaneous multi-layer coating may be carried out in which two or more coating liquids are applied at the same time. It is preferable to carry out a smoothing treatment by using a known smoothing method, such as a super calendar or a soft calendar, in a certain process after each layer is formed or after all layers are formed. The surface smoothing treatment makes it possible to improve the recording sensitivity and to enhance the uniformity of the formed image.

<Image Forming Method>

Next, the image forming method of the present invention will be described. The image forming method of the present invention includes a step of forming an image by applying a heat pulse to the above-mentioned thermosensitive recording medium using a thermal head (image forming step) and a step of fixing the thermosensitive coloring layer by irradiating the thermosensitive recording medium on which the image is formed with an ultraviolet ray (fixing step).

The temperature of the heat pulse applied to the thermosensitive recording medium in the image forming step can be, for example, 80° C. or higher to 120° C. or lower. A desired image can be formed by applying a heat pulse to the thermosensitive coloring layer of the thermosensitive recording medium in a state where the thermal head is in contact with the thermosensitive recording medium. Specifically, the radical polymerizable compound contained in the thermosensitive coloring layer is dissolved by applying a heat pulse to heat the layer. In a case where the radical polymerizable compound is dissolved, the electron-donating dye precursor and the electron-accepting compound come into contact with each other to develop the thermosensitive coloring layer, whereby an image can be formed.

In the fixing step, the thermosensitive recording medium on which the image is formed is irradiated with an ultraviolet ray. The wavelength of the ultraviolet ray for irradiation may be a wavelength at which the radical polymerization initiator contained in the thermosensitive coloring layer can react, and may be, for example, 365 nm or longer to 425 nm or shorter. Ultraviolet irradiation can lead to a polymerization reaction of the radical polymerizable compound, by which the thermosensitive coloring layer can be fixed. In a case where the thermosensitive coloring layer is fixed, the thermosensitive coloring layer does not develop color even in a case where heat energy reaching a coloring starting temperature is subsequently applied, so that the color development property of the formed image can be maintained for a long period of time. The wavelength of the ultraviolet ray in the present specification means a peak wavelength of an ultraviolet ray for irradiation.

### EXAMPLES

Hereinafter, the present invention will be described in more detail with reference to Examples and Comparative Examples, but the present invention is not limited to the following Examples as long as the scope and spirit of the present invention are not changed. Unless otherwise specified, those described as “parts” and “%” regarding the amount of components are based on mass.

<Production of Thermosensitive Recording Medium (1)>

### Example 1

[Preparation of Raw Material Composition]

The following materials were mixed and dissolved to prepare liquids [A] and [B], respectively.

Liquid [A]: composition containing an electron-donating dye precursor

| | |
|---|---|
| 3-diethylamino-7-(o-fluoroanilino)fluoran | 40 parts |
| (BK-400, manufactured by Fukui Yamada Chemical Co., Ltd.) | |
| tris(2-hydroxyethyl)isocyanurate triacrylate | 47 parts |
| (SR368, manufactured by Tomoe Engineering Co., Ltd.) | |
| Dispersant (EFKA7710, manufactured by BASF SE) | 3 parts |
| Photopolymerization initiator (Omnirad 184, manufactured by | 10 parts |
| IGM Resin Corporation) | |
| Methyl ethyl ketone | 120 parts |

Liquid [B]: composition containing an electron-accepting compound

| | |
|---|---|
| 2,4′-dihydroxydiphenylsulfone (24BPS, manufactured by Nicca Chemical Co., Ltd.) | 40 parts |
| tris(2-hydroxyethyl)isocyanurate triacrylate | |
| (SR368, manufactured by Tomoe Engineering Co., Ltd.) | 47 parts |
| Dispersant (EFKA7710, manufactured by BASF SE) | 3 parts |
| Photopolymerization initiator (Omnirad 184, manufactured by IGM Resin | 10 parts |
| Corporation) | |
| Methyl ethyl ketone | 120 parts |

[Formation of Thermosensitive Coloring Layer]

The liquid [A] was applied onto a synthetic paper (YUPO, manufactured by Yupo Corporation) having a thickness of 130 μm using a printability tester, and then dried with a dryer to evaporate methyl ethyl ketone. The coating amount of the liquid [A] after drying was 3.0 g/m², and the coating amount of BK-400 was 1.20 g/m². Then, a 10% aqueous solution of partially saponified polyvinyl alcohol (KURARAY POVAL 5-88, manufactured by Kuraray Co., Ltd.) having a degree of polymerization of 500 was applied using a printability tester, and then dried with a dryer. The coating amount after drying was 0.2 g/m². After that, the liquid [B] was applied using a printability tester and then dried with a dryer to evaporate methyl ethyl ketone to form a thermosensitive coloring layer. The coating amount of the liquid [B] after drying was 7.0 g/m², and the coating amount of 24BPS was 2.80 g/m².

[Preparation of Kaolin Dispersion Liquid (Liquid C)]

Using Kolese, 59.5 parts of kaolin, 0.5 parts of dispersant and 40 parts of water were dispersed for 1 hour to obtain a kaolin dispersion liquid (liquid C). A product under the trade name of “HYDRAGLOSS 90” (manufactured by KaMin LLC) was used as the kaolin. A product under the trade name of “ARON T-50” (solid content concentration: 40%, manufactured by Toagosei Co., Ltd.) was used as the dispersant.

[Formation of Protective Layer]

210 parts of a 10% aqueous solution of acetoacetyl-modified polyvinyl alcohol A, 80 parts of a 20% aqueous solution of acetoacetyl-modified polyvinyl alcohol B, 100 parts of liquid C, 5.6 parts of an aqueous dispersion of zinc stearate and 2.5 parts of a polyethylene wax emulsion were prepared. These components were mixed and stirred to obtain a coating liquid for a protective layer. A product under the trade name of “GOHSEFIMER Z-200” (saponification degree: 99.4 mol %, average degree of polymerization: 1,000, modification degree: 5 mol %, manufactured by Nihon Gosei Kako Co., Ltd.) was used as the acetoacetyl-modified polyvinyl alcohol A. A product under the trade name of “GOHSEFIMER Z-100” (saponification degree: 99.4 mol %, average degree of polymerization: 500, modification degree: 5 mol %, manufactured by Nihon Gosei Kako Co., Ltd.) was used as the acetoacetyl-modified polyvinyl alcohol B. A product under the trade name of “HIDORIN Z-8-36” (solid content concentration: 36%, manufactured by Chukyo Yushi Co., Ltd.) was used as the aqueous dispersion of zinc stearate. A product under the trade name of “CHEMIPEARL W-400” (solid content concentration: 40%, manufactured by Mitsui Chemicals, Inc.) was used as the polyethylene wax emulsion.

The obtained coating liquid for a protective layer was applied and dried onto the thermosensitive coloring layer such that the coating amount after drying was 1.5 g/m² to form a protective layer. Then, the surface of the formed layer was smoothed with a super calendar to obtain a thermosensitive recording medium.

### Example 2

A thermosensitive recording medium was obtained in the same manner as in Example 1 described above, except that the liquid [A] prepared by changing the amount of tris(2-hydroxyethyl)isocyanurate triacrylate to 22 parts was used.

### Example 3

A thermosensitive recording medium was obtained in the same manner as in Example 1 described above, except that the liquid [A] prepared by changing the amount of tris(2-hydroxyethyl)isocyanurate triacrylate to 8 parts was used.

### Example 4

A thermosensitive recording medium was obtained in the same manner as in Example 1 described above, except that the liquid [A] prepared by changing the amount of tris(2-hydroxyethyl)isocyanurate triacrylate to 2 parts was used.

### Example 5

A thermosensitive recording medium was obtained in the same manner as in Example 1 described above, except that the liquid [A] prepared by changing the amount of tris(2-hydroxyethyl)isocyanurate triacrylate to 120 parts was used.

### Example 6

A thermosensitive recording medium was obtained in the same manner as in Example 1 described above, except that the liquid [A] prepared by changing the amount of tris(2-hydroxyethyl)isocyanurate triacrylate to 192 parts was used.

### Example 7

A thermosensitive recording medium was obtained in the same manner as in Example 1 described above, except that the liquid [A] prepared by changing the amount of tris(2-hydroxyethyl)isocyanurate triacrylate to 220 parts was used.

### Example 8

A thermosensitive recording medium was obtained in the same manner as in Example 1 described above, except that the liquid [A] prepared by changing the amount of tris(2-hydroxyethyl)isocyanurate triacrylate to 360 parts was used.

### Example 9

A thermosensitive recording medium was obtained in the same manner as in Example 1 described above, except that the liquid [A] prepared by changing the amount of tris(2-hydroxyethyl)isocyanurate triacrylate to 420 parts was used.

### Example 10

Liquid [A] and liquid [B] were prepared in the same manner as in Example 1 described above, except that ethoxylated bisphenol A diacrylate (2 mol of EO added) was used instead of tris(2-hydroxyethyl)isocyanurate triacrylate. A product under the trade name of “A-BPE-2” (manufactured by Shin-Nakamura Chemical Co., Ltd.) was used as the ethoxylated bisphenol A diacrylate (2 mol of EO added). Then, a thermosensitive recording medium was obtained in the same manner as in Example 1 described above, except that the prepared liquid [A] and liquid [B] were used.

### Example 11

45 parts of ethoxylated bisphenol A diacrylate (2 mol of EO added) and 2 parts of a composition containing a methacrylate copolymer were used instead of tris(2-hydroxyethyl)isocyanurate triacrylate. Except for this, a liquid [A] and a liquid [B] were prepared in the same manner as in Example 1 described above. A product under the trade name of “A-BPE-2” (manufactured by Shin-Nakamura Chemical Co., Ltd.) was used as the ethoxylated bisphenol A diacrylate (2 mol of EO added). A product under the trade name of “VANARESIN GH-9903” (manufactured by Shin-Nakamura Chemical Co., Ltd.) was used as the composition containing a methacrylate copolymer. Then, a thermosensitive recording medium was obtained in the same manner as in Example 1 described above, except that the prepared liquid [A] and liquid [B] were used.

### Example 12

42 parts of ethoxylated bisphenol A diacrylate (2 mol of EO added) and 5 parts of a composition containing a methacrylate copolymer were used instead of tris(2-hydroxyethyl)isocyanurate triacrylate. Except for this, a liquid [A] and a liquid [B] were prepared in the same manner as in Example 1 described above. A product under the trade name of “A-BPE-2” (manufactured by Shin-Nakamura Chemical Co., Ltd.) was used as the ethoxylated bisphenol A diacrylate (2 mol of EO added). A product under the trade name of “VANARESIN GH-9903” (manufactured by Shin-Nakamura Chemical Co., Ltd.) was used as the composition containing a methacrylate copolymer. Then, a thermosensitive recording medium was obtained in the same manner as in Example 1 described above, except that the prepared liquid [A] and liquid [B] were used.

### Example 13

33 parts of ethoxylated bisphenol A diacrylate (2 mol of EO added) and 14 parts of a composition containing a methacrylate copolymer were used instead of tris(2-hydroxyethyl)isocyanurate triacrylate. Except for this, a liquid [A] and a liquid [B] were prepared in the same manner as in Example 1 described above. A product under the trade name of “A-BPE-2” (manufactured by Shin-Nakamura Chemical Co., Ltd.) was used as the ethoxylated bisphenol A diacrylate (2 mol of EO added). A product under the trade name of “VANARESIN GH-9903” (manufactured by Shin-Nakamura Chemical Co., Ltd.) was used as the composition containing a methacrylate copolymer. Then, a thermosensitive recording medium was obtained in the same manner as in Example 1 described above, except that the prepared liquid [A] and liquid [B] were used.

### Example 14

24 parts of ethoxylated bisphenol A diacrylate (2 mol of EO added) and 23 parts of a composition containing a methacrylate copolymer were used instead of tris(2-hydroxyethyl)isocyanurate triacrylate. Except for this, a liquid [A] and a liquid [B] were prepared in the same manner as in Example 1 described above. A product under the trade name of “A-BPE-2” (manufactured by Shin-Nakamura Chemical Co., Ltd.) was used as the ethoxylated bisphenol A diacrylate (2 mol of EO added). A product under the trade name of “VANARESIN GH-9903” (manufactured by Shin-Nakamura Chemical Co., Ltd.) was used as the composition containing a methacrylate copolymer. Then, a thermosensitive recording medium was obtained in the same manner as in Example 1 described above, except that the prepared liquid [A] and liquid [B] were used.

### Example 15

Liquid [A] and liquid [B] were prepared in the same manner as in Example 1 described above, except that a UV-curable acrylic polymer (8KX-078, manufactured by Taisei Fine Chemical Co., Ltd.) was used instead of tris(2-hydroxyethyl)isocyanurate triacrylate. Then, a thermosensitive recording medium was obtained in the same manner as in Example 1 described above, except that the prepared liquid [A] and liquid [B] were used.

### Example 16

Liquid [A] and liquid [B] were prepared in the same manner as in Example 1 described above, except that a composition containing a methacrylate copolymer was used instead of tris(2-hydroxyethyl)isocyanurate triacrylate. A product under the trade name of “VANARESIN GH-9903” (manufactured by Shin-Nakamura Chemical Co., Ltd.) was used as the composition containing a methacrylate copolymer. Then, a thermosensitive recording medium was obtained in the same manner as in Example 1 described above, except that the prepared liquid [A] and liquid [B] were used.

### Example 17

Liquid [A] and liquid [B] were prepared in the same manner as in Example 1 described above, except that a UV-curable acrylic polymer (8KX-212, manufactured by Taisei Fine Chemical Co., Ltd.) was used instead of tris(2-hydroxyethyl)isocyanurate triacrylate. Then, a thermosensitive recording medium was obtained in the same manner as in Example 1 described above, except that the prepared liquid [A] and liquid [B] were used.

### Example 18

Liquid [A] and liquid [B] were prepared in the same manner as in Example 1 described above, except that a composition containing a methacrylate copolymer was used instead of tris(2-hydroxyethyl)isocyanurate triacrylate. A product under the trade name of “VANARESIN GH-1203” (manufactured by Shin-Nakamura Chemical Co., Ltd.) was used as the composition containing a methacrylate copolymer. Then, a thermosensitive recording medium was obtained in the same manner as in Example 1 described above, except that the prepared liquid [A] and liquid [B] were used.

### Comparative Example 1

[Preparation of Raw Material Composition]

After mixing the following materials, the solid content was pulverized and dispersed using a bead mill to prepare liquid [A] and liquid [B], respectively.

Liquid [A]: composition containing an electron-donating dye precursor

| | |
|---|---|
| 3-diethylamino-7-(o-fluoroanilino)fluoran | 40 parts |
| (BK-400, manufactured by Fukui Yamada Chemical Co., Ltd.) | |
| Hexanediol diacrylate (HDDA, manufactured by BASF SE) | 43 parts |
| Dipentaerythritol hexaacrylate | 4 parts |
| (A-DPH, manufactured by Shin-Nakamura Chemical Co., Ltd.) | |
| Dispersant (EFKA7710, manufactured by BASF SE) | 3 parts |
| Photopolymerization initiator (Omnirad 184, manufactured by | 10 parts |
| IGM Resin Corporation) | |

Liquid [B]: composition containing an electron-accepting compound

| | |
|---|---|
| 2,4′-dihydroxydiphenylsulfone (24BPS, manufactured by Nicca Chemical Co., Ltd.) | 40 parts |
| Hexanediol diacrylate (HDDA, manufactured by BASF SE) | 43 parts |
| Dipentaerythritol hexaacrylate | 4 parts |
| (A-DPH, manufactured by Shin-Nakamura Chemical Co., Ltd.) | |
| Dispersant (EFKA7710, manufactured by BASF SE) | 3 parts |
| Photopolymerization initiator (Omnirad 184, manufactured by IGM Resin | 10 parts |
| Corporation) | |

[Formation of Thermosensitive Coloring Layer]

The liquid [A], the liquid [B] and the epoxy compound polyglycerol polyglycidyl ether were mixed at a ratio of 30 parts:70 parts:3 parts to prepare a thermosensitive coloring composition. A product under the trade name of “DENACOL EX-521” (manufactured by Nagase ChemteX Corporation) was used as the polyglycerol polyglycidyl ether. Using a printability tester, the thermosensitive coloring composition was applied onto a synthetic paper (YUPO, manufactured by Yupo Corporation) having a thickness of 130 μm such that the coating amount was 10.0 g/m². Next, using an ultraviolet irradiation device (ME12-L61, manufactured by Eye Graphics Co., Ltd.) equipped with a metal halide lamp (120 W/cm), the applied thermosensitive coloring composition was cured by irradiation with ultraviolet rays three times at a conveyor speed of 100 m/min to form a thermosensitive coloring layer. The coating amount of BK-400 was 1.20 g/m², and the coating amount of 24BPS was 2.80 g/m².

[Formation of Protective Layer]

Using a printability tester, an ultraviolet curable resin (UVMC315 modified ST, manufactured by T & K Toka Co., Ltd.) was applied onto the thermosensitive coloring layer such that the coating amount was 1.5 g/m². Next, using an ultraviolet irradiation device (ME12-L61, manufactured by Eye Graphics Co., Ltd.) equipped with a metal halide lamp (120 W/cm), the applied ultraviolet curable resin was cured by irradiation with ultraviolet rays three times at a conveyor speed of 100 m/min to form a protective layer, thereby obtaining a thermosensitive recording medium.

### Comparative Example 2

Liquid [A] and liquid [B] were prepared in the same manner as in Comparative Example 1 described above, except that EO-modified hexanediol diacrylate (MIRAMER M202, manufactured by Miwon Specialty Chemical Co., Ltd., repeating number n of oxyethylene group: 2) was used instead of hexanediol diacrylate. Then, a thermosensitive recording medium was obtained in the same manner as in Comparative Example 1 described above, except that the prepared liquid [A] and liquid [B] were used.

### Comparative Example 3

Liquid [A] and liquid [B] were prepared in the same manner as in Comparative Example 1 described above, except that PO-modified hexanediol diacrylate (PHOTOMER 4362, manufactured by Cognis Corporation, repeating number n of oxypropylene group: 2) was used instead of hexanediol diacrylate. Then, a thermosensitive recording medium was obtained in the same manner as in Comparative Example 1 described above, except that the prepared liquid [A] and liquid [B] were used.

### Comparative Example 4

[Preparation of Raw Material Composition]

After mixing the following materials, the solid content was pulverized and dispersed using a bead mill to prepare liquid [A] and liquid [B], respectively.

Liquid [A]: composition containing an electron-donating dye precursor

| | |
|---|---|
| 3-diethylamino-7-(o-fluoroanilino)fluoran | 40 parts |
| (BK-400, manufactured by Fukui Yamada Chemical Co., Ltd.) | |
| Hexanediol diacrylate (HDDA, manufactured by BASF SE) | 43 parts |
| Dipentaerythritol hexaacrylate | 4 parts |
| (A-DPH, manufactured by Shin-Nakamura Chemical Co., Ltd.) | |
| Dispersant (EFKA7710, manufactured by BASF SE) | 3 parts |
| Photopolymerization initiator (Omnirad 184, manufactured by | 10 parts |
| IGM Resin Corporation) | |

Liquid [B]: composition containing an electron-accepting compound

| | |
|---|---|
| 2,4′-dihydroxydiphenylsulfone (24BPS, manufactured by Nicca Chemical Co., Ltd.) | 40 parts |
| Hexanediol diacrylate (HDDA, manufactured by BASF SE) | 43 parts |
| Dipentaerythritol hexaacrylate | 4 parts |
| (A-DPH, manufactured by Shin-Nakamura Chemical Co., Ltd.) | |
| Dispersant (EFKA7710, manufactured by BASF SE) | 3 parts |
| Photopolymerization initiator (Omnirad 184, manufactured by IGM Resin | 10 parts |
| Corporation) | |

[Formation of Thermosensitive Coloring Layer]

Using a printability tester, the liquid [A] was applied onto a synthetic paper (YUPO, manufactured by Yupo Corporation) having a thickness of 130 μm such that the coating amount was 3.0 g/m². Next, using an ultraviolet irradiation device (ME12-L61, manufactured by Eye Graphics Co., Ltd.) equipped with a metal halide lamp (120 W/cm), the applied liquid [A] was irradiated with ultraviolet rays three times at a conveyor speed of 100 m/min for a curing treatment. The coating amount of BK-400 was 1.20 g/m². Next, a 10% by mass aqueous solution of partially saponified polyvinyl alcohol (KURARAY POVAL 5-88, manufactured by Kuraray Co., Ltd.) having a degree of polymerization of 500 was applied and then dried with a dryer. The coating amount after drying was 0.2 g/m². Then, using a printability tester, the liquid [B] was applied such that the coating amount was 7.0 g/m². Using an ultraviolet irradiation device (ME12-L61, manufactured by Eye Graphics Co., Ltd.) equipped with a metal halide lamp (120 W/cm), the applied liquid [B] was irradiated with ultraviolet rays twice at a conveyor speed of 100 m/min for a curing treatment to form a thermosensitive coloring layer. The coating amount of 24BPS was 2.80 g/m².

[Preparation of Kaolin Dispersion Liquid (Liquid C)]

Using Kolese, 59.5 parts of kaolin, 0.5 parts of dispersant and 40 parts of water were dispersed for 1 hour to obtain a kaolin dispersion liquid (liquid C). A product under the trade name of “HYDRAGLOSS 90” (manufactured by KaMin LLC) was used as the kaolin. A product under the trade name of “ARON T-50” (solid content concentration: 40%, manufactured by Toagosei Co., Ltd.) was used as the dispersant.

[Formation of Protective Layer]

210 parts of a 10% aqueous solution of acetoacetyl-modified polyvinyl alcohol A, 80 parts of a 20% aqueous solution of acetoacetyl-modified polyvinyl alcohol B, 100 parts of liquid C, 5.6 parts of an aqueous dispersion of zinc stearate and 2.5 parts of a polyethylene wax emulsion were prepared. These components were mixed and stirred to obtain a coating liquid for a protective layer. A product under the trade name of “GOHSEFIMER Z-200” (saponification degree: 99.4 mol %, average degree of polymerization: 1,000, modification degree: 5 mol %, manufactured by Nihon Gosei Kako Co., Ltd.) was used as the acetoacetyl-modified polyvinyl alcohol A. A product under the trade name of “GOHSEFIMER Z-100” (saponification degree: 99.4 mol %, average degree of polymerization: 500, modification degree: 5 mol %, manufactured by Nihon Gosei Kako Co., Ltd.) was used as the acetoacetyl-modified polyvinyl alcohol B. A product under the trade name of “HIDORIN Z-8-36” (solid content concentration: 36%, manufactured by Chukyo Yushi Co., Ltd.) was used as the aqueous dispersion of zinc stearate. A product under the trade name of “CHEMIPEARL W-400” (solid content concentration: 40%, manufactured by Mitsui Chemicals, Inc.) was used as the polyethylene wax emulsion.

The obtained coating liquid for a protective layer was applied and dried onto the thermosensitive coloring layer such that the coating amount after drying was 1.5 g/m² to form a protective layer. Then, the surface of the formed layer was smoothed with a super calendar to obtain a thermosensitive recording medium.

### Comparative Example 5

Liquid [A] and liquid [B] were prepared in the same manner as in Comparative Example 4 described above, except that EO-modified hexanediol diacrylate (MIRAMER M202, manufactured by Miwon Specialty Chemical Co., Ltd., repeating number n of oxyethylene group: 2) was used instead of hexanediol diacrylate. Then, a thermosensitive recording medium was obtained in the same manner as in Comparative Example 4 described above, except that the prepared liquid [A] and liquid [B] were used.

### Comparative Example 6

Liquid [A] and liquid [B] were prepared in the same manner as in Comparative Example 4 described above, except that PO-modified hexanediol diacrylate (PHOTOMER 4362, manufactured by Cognis Corporation, repeating number n of oxypropylene group: 2) was used instead of hexanediol diacrylate. Then, a thermosensitive recording medium was obtained in the same manner as in Comparative Example 4 described above, except that the prepared liquid [A] and liquid [B] were used.

<Evaluation (1)>

(Storage Stability)

Using a reflection densitometer (trade name: “Xrite530”, manufactured by Sakata Inx Corporation), the optical reflection density of the thermosensitive recording medium before storage (on the day of production), after storage in an incubator at 50° C. for 1 month and after storage in an incubator at 50° C. for 3 months was measured. The results are shown in Table 1.

(Color Development Property)

Using a thermal head (KPE model series, manufactured by Kyocera Corporation), the application electric power and the pulse width were set such that the recording energy per unit area was 90 mJ/mm², 120 mJ/mm² and 150 mJ/mm², and an image of 2 cm×2 cm was formed on the thermosensitive recording medium. The optical reflection density of the formed image was measured using a reflection densitometer (trade name: “Xrite530”, manufactured by Sakata Inx Corporation). The results are shown in Table 1.

TABLE 1

| | Radical polymerizable compound | | | | | | | | |
|---|---|---|---|---|---|---|---|---|---|
| | | (weight | | Storability | | | Color developability | | |
| | Melting | average) | Glass | (optical reflection density) | | | (optical reflection density) | | |
| | point | Molecular | transition | Before | 50° C. | 50° C. | 90 | 120 | 150 |
| | (° C.) | weight | point (° C.) | storage | 1 month | 3 months | mJ/mm² | mJ/mm² | mJ/mm² |
| Example 1 | 53 | 423 | ≤30 | 0.06 | 0.08 | 0.32 | 0.85 | 1.45 | 1.92 |
| Example 2 | 53 | 423 | ≤30 | 0.06 | 0.08 | 0.33 | 0.86 | 1.45 | 1.96 |
| Example 3 | 53 | 423 | ≤30 | 0.06 | 0.09 | 0.35 | 0.88 | 1.46 | 2.03 |
| Example 4 | 53 | 423 | ≤30 | 0.06 | 0.10 | 0.41 | 0.89 | 1.49 | 2.08 |
| Example 5 | 53 | 423 | ≤30 | 0.06 | 0.07 | 0.32 | 0.85 | 1.42 | 1.88 |
| Example 6 | 53 | 423 | ≤30 | 0.06 | 0.07 | 0.30 | 0.81 | 1.41 | 1.85 |
| Example 7 | 53 | 423 | ≤30 | 0.06 | 0.07 | 0.30 | 0.75 | 1.38 | 1.78 |
| Example 8 | 53 | 423 | ≤30 | 0.06 | 0.07 | 0.29 | 0.72 | 1.33 | 1.70 |
| Example 9 | 53 | 423 | ≤30 | 0.06 | 0.07 | 0.29 | 0.68 | 1.28 | 1.55 |
| Example 10 | 63 | 425 | ≤30 | 0.06 | 0.08 | 0.28 | 0.84 | 1.46 | 1.93 |
| Example 11 | 63 | 928 | ≤30 | 0.06 | 0.07 | 0.25 | 0.85 | 1.45 | 1.94 |
| Example 12 | 63 | 1,432 | ≤30 | 0.06 | 0.07 | 0.21 | 0.84 | 1.45 | 1.92 |
| Example 13 | 63 | 3,447 | ≤30 | 0.06 | 0.07 | 0.20 | 0.85 | 1.44 | 1.95 |
| Example 14 | 63 | 5,462 | ≤30 | 0.06 | 0.07 | 0.20 | 0.84 | 1.44 | 1.93 |
| Example 15 | ≥60 | 40,000 | 53 | 0.06 | 0.06 | 0.14 | 0.85 | 1.47 | 1.93 |
| Example 16 | ≥60 | 10,500 | 63 | 0.06 | 0.06 | 0.16 | 0.86 | 1.46 | 1.92 |
| Example 17 | ≥110 | 100,000 | 110 | 0.06 | 0.06 | 0.12 | 0.84 | 1.44 | 1.91 |
| Example 18 | ≥60 | 13,000 | 41 | 0.06 | 0.06 | 0.15 | 0.85 | 1.46 | 1.96 |
| Comparative | 7 | 256 | <0 | 0.19 | 0.60 | 0.91 | 0.21 | 0.72 | 1.41 |
| Example 1 | | | | | | | | | |
| Comparative | ≤0 | 337 | <0 | 0.20 | 0.66 | 0.98 | 0.22 | 0.88 | 2.01 |
| Example 2 | | | | | | | | | |
| Comparative | ≤0 | 362 | <0 | 0.17 | 0.58 | 0.88 | 0.21 | 0.89 | 2.06 |
| Example 3 | | | | | | | | | |
| Comparative | 7 | 256 | <0 | 0.08 | 0.13 | 0.32 | 0.09 | 0.21 | 0.42 |
| Example 4 | | | | | | | | | |
| Comparative | ≤0 | 337 | <0 | 0.09 | 0.15 | 0.38 | 0.10 | 0.22 | 0.51 |
| Example 5 | | | | | | | | | |
| Comparative | ≤0 | 362 | <0 | 0.08 | 0.12 | 0.31 | 0.09 | 0.22 | 0.50 |
| Example 6 | | | | | | | | | |

As shown in Table 1, it can be seen that the thermosensitive recording bodies of Comparative Examples 1 to 3 showed significant fogging in a case of being stored at 50° C. In addition, it can be seen that the thermosensitive recording bodies of Comparative Examples 1 to 3 need to apply a large energy of about 150 mJ/mm² in order to form an image having sufficient color development property. It can be seen that the thermosensitive recording bodies of Comparative Examples 4 to 6 did not show any significant fogging even after being stored at 50° C., but had insufficient color development property of the image even in a case where a large energy of about 150 mJ/mm² was applied. On the other hand, it can be seen that the thermosensitive recording bodies of Examples 1 to 9 had excellent storage stability and showed the formation of an image having excellent color development property even at low energy.

Upon comparing the results of Example 1 and Example 10, it can be seen that the color development property of the image is not deteriorated and the storage stability is improved in a case where the melting point of the radical polymerizable compound is 60° C. or higher. In addition, upon comparing the results of Example 11 with the results of Examples 12, 13 and 14, it can be seen that the color development property of the image is not deteriorated and the storage stability is improved in a case where the molecular weight of the radical polymerizable compound is 1,000 or more.

In addition, upon comparing the results of Examples 12, 13 and 14 with the results of Example 16, it can be seen that the color development property of the image is not deteriorated and the storage stability is improved in a case where the glass transition point of the radical polymerizable compound is 40° C. or higher. Further, upon comparing the results of Examples 12, 13 and 14 with the results of Example 16, it can be seen that the color development property of the image is not deteriorated and the storage stability is improved in a case where the molecular weight of the radical polymerizable compound is 10,000 or more.

An image was formed on the thermosensitive recording medium of each of Examples 1 to 18 under the same conditions as in the above-mentioned evaluation of “color development property”. Then, using an ultraviolet irradiation device (ME12-L61, manufactured by Eye Graphics Co., Ltd.) equipped with a metal halide lamp (120 W/cm), the thermosensitive recording medium was irradiated with ultraviolet rays three times at a conveyor speed of 100 m/min. As a result, it was confirmed that any of the thermosensitive recording bodies showed no occurrence of fogging and no change in the color development property of the image. Furthermore, it was confirmed that any of the thermosensitive recording bodies showed no occurrence of fogging and no change in the color development property of the image even in a case of being stored at 50° C. for 3 months after the image was formed.

<Production of Thermosensitive Recording Medium (2)>

### Example 19

[Preparation of Raw Material Composition]

The following materials were mixed and dissolved to prepare an [oil phase A] liquid, an [oil phase B] liquid and a [water phase C] liquid, respectively.

[Oil phase A] liquid: composition containing an electron-donating dye
precursor

| | |
|---|---|
| 3 -(1-ethyl-2-methylindol-3-yl)-3 -(4-diethyl amino-2-methylphenyl)-4-azaphthalide | 40 parts |
| (BLUE220, manufactured by Fukui Yamada Chemical Co., Ltd.) | |
| Radical polymerizable compound (8KX-078, manufactured by Taisei Fine Chemical | 47 parts |
| Co., Ltd.) | |
| Photopolymerization initiator (Omnirad TPO, manufactured by IGM Resin | 13 parts |
| Corporation) | |
| Ethyl acetate | 120 parts |

[Oil phase B] liquid: composition containing an electron-accepting
compound

| | |
|---|---|
| 2,2′-diallyl-4,4′-sulfonyldiphenol (TGSH (H), manufactured by Nippon Kayaku Co., | 40 parts |
| Ltd.) | |
| Radical polymerizable compound (8KX-078, manufactured by Taisei Fine Chemical | 47 parts |
| Co., Ltd.) | |
| Photopolymerization initiator (Omnirad TPO, manufactured by IGM Resin | 13 parts |
| Corporation) | |
| Ethyl acetate | 120 parts |

[Water phase C] liquid

| | |
|---|---|
| Polyvinyl alcohol (KURARAY POVAL 5-88, manufactured by Kuraray Co., Ltd.) | 2.5 parts |
| Sodium di-2-ethylhexyl sulfosuccinate | 1.0 part |
| Sodium polyacrylate (ARON T-50, manufactured by Toagosei Co., Ltd.) | 1.0 part |
| Boric acid | 0.02 parts |
| Sodium tetraborate decahydrate | 0.02 parts |
| Water | 95.5 parts |

[Preparation of Electron-Donating Dye Precursor-Containing Particle Dispersion Liquid]

80 parts of the [oil phase A] liquid and 100 parts of the [water phase C] liquid were mixed, and then emulsified using an ultrasonic homogenizer (UH-600S, manufactured by SMT Co., Ltd.). Then, the ethyl acetate was removed under reduced pressure using a rotary evaporator to obtain an electron-donating dye precursor-containing particle dispersion liquid. The particle size (D50) of the particles in the electron-donating dye precursor-containing particle dispersion liquid, which was measured using a particle size distribution analyzer (NANOTRAC, manufactured by MicrotracBEL Corp.), was 150 nm.

[Preparation of Electron-Accepting Compound-Containing Particle Dispersion Liquid]

80 parts of the [oil phase B] liquid and 100 parts of the [water phase C] liquid were mixed, and then emulsified using an ultrasonic homogenizer (UH-600S, manufactured by SMT Co., Ltd.). Then, the ethyl acetate was removed under reduced pressure using a rotary evaporator to obtain an electron-accepting compound-containing particle dispersion liquid. The particle size (D50) of the particles in the electron-accepting compound-containing particle dispersion liquid, which was measured using a particle size distribution analyzer (NANOTRAC, manufactured by MicrotracBEL Corp.), was 140 nm.

[Formation of Thermosensitive Coloring Layer]

10 parts of the electron-donating dye precursor-containing particle dispersion liquid and 40 parts of the electron-accepting compound-containing particle dispersion liquid were mixed, and then the mixture was applied onto a synthetic paper (YUPO, manufactured by Yupo Corporation) having a thickness of 130 μm such that the coating amount after drying was 11.25 g/m². This was followed by drying to form a thermosensitive coloring layer. The coating amount of BLUE220 was 0.20 g/m², and the coating amount of TGSH (H) was 1.00 g/m².

[Preparation of Kaolin Dispersion Liquid (Liquid C)]

Using Kolese, 59.5 parts of kaolin, 0.5 parts of dispersant and 40 parts of water were dispersed for 1 hour to obtain a kaolin dispersion liquid (liquid C). A product under the trade name of “HYDRAGLOSS 90” (manufactured by KaMin LLC) was used as the kaolin. A product under the trade name of “ARON T-50” (solid content concentration: 40%, manufactured by Toagosei Co., Ltd.) was used as the dispersant.

[Formation of Protective Layer]

210 parts of a 10% aqueous solution of acetoacetyl-modified polyvinyl alcohol A, 80 parts of a 20% aqueous solution of acetoacetyl-modified polyvinyl alcohol B, 100 parts of liquid C, 5.6 parts of an aqueous dispersion of zinc stearate and 2.5 parts of a polyethylene wax emulsion were prepared. These components were mixed and stirred to obtain a coating liquid for a protective layer. A product under the trade name of “GOHSEFIMER Z-200” (saponification degree: 99.4 mol %, average degree of polymerization: 1,000, modification degree: 5 mol %, manufactured by Nihon Gosei Kako Co., Ltd.) was used as the acetoacetyl-modified polyvinyl alcohol A. A product under the trade name of “GOHSEFIMER Z-100” (saponification degree: 99.4 mol %, average degree of polymerization: 500, modification degree: 5 mol %, manufactured by Nihon Gosei Kako Co., Ltd.) was used as the acetoacetyl-modified polyvinyl alcohol B. A product under the trade name of “HIDORIN Z-8-36” (solid content concentration: 36%, manufactured by Chukyo Yushi Co., Ltd.) was used as the aqueous dispersion of zinc stearate. A product under the trade name of “CHEMIPEARL W-400” (solid content concentration: 40%, manufactured by Mitsui Chemicals, Inc.) was used as the polyethylene wax emulsion.

The obtained coating liquid for a protective layer was applied and dried onto the thermosensitive coloring layer such that the coating amount after drying was 1.5 g/m² to form a protective layer. Then, the surface of the formed layer was smoothed with a super calendar to obtain a thermosensitive recording medium.

### Example 20

An [oil phase A] liquid and an [oil phase B] liquid were prepared in the same manner as in Example 19 described above, except that a composition containing a methacrylate copolymer (VANARESIN GH-9903, manufactured by Shin-Nakamura Chemical Co., Ltd.) was used as the radical polymerizable compound. Then, a thermosensitive recording medium was obtained in the same manner as in Example 19 described above, except that the prepared [oil phase A] liquid and [oil phase B] liquid were used.

### Example 21

An [oil phase A] liquid and an [oil phase B] liquid were prepared in the same manner as in Example 19 described above, except that a composition containing a UV-curable acrylic polymer (8KX-212, manufactured by Taisei Fine Chemical Co., Ltd.) was used as the radical polymerizable compound. Then, a thermosensitive recording medium was obtained in the same manner as in Example 19 described above, except that the prepared [oil phase A] liquid and [oil phase B] liquid were used.

### Example 22

An [oil phase A] liquid and an [oil phase B] liquid were prepared in the same manner as in Example 19 described above, except that a composition containing a methacrylate copolymer (VANARESIN GH-1203, manufactured by Shin-Nakamura Chemical Co., Ltd.) was used as the radical polymerizable compound. Then, a thermosensitive recording medium was obtained in the same manner as in Example 19 described above, except that the prepared [oil phase A] liquid and [oil phase B] liquid were used.

### Example 23

An [oil phase A] liquid and an [oil phase B] liquid were prepared in the same manner as in Example 19 described above, except that 23 parts of the composition containing a methacrylate copolymer and 24 parts of the ethoxylated bisphenol A diacrylate (2 mol of EO added) were used as the radical polymerizable compound. A product under the trade name of “VANARESIN GH-9903” (manufactured by Shin-Nakamura Chemical Co., Ltd.) was used as the composition containing a methacrylate copolymer. A product under the trade name of “A-BPE-2” (manufactured by Shin-Nakamura Chemical Co., Ltd.) was used as the ethoxylated bisphenol A diacrylate (2 mol of EO added). Then, a thermosensitive recording medium was obtained in the same manner as in Example 19 described above, except that the prepared [oil phase A] liquid and [oil phase B] liquid were used.

### Example 24

An [oil phase A] liquid and an [oil phase B] liquid were prepared in the same manner as in Example 19 described above, except that 14 parts of the composition containing a methacrylate copolymer and 33 parts of the ethoxylated bisphenol A diacrylate (2 mol of EO added) were used as the radical polymerizable compound. A product under the trade name of “VANARESIN GH-9903” (manufactured by Shin-Nakamura Chemical Co., Ltd.) was used as the composition containing a methacrylate copolymer. A product under the trade name of “A-BPE-2” (manufactured by Shin-Nakamura Chemical Co., Ltd.) was used as the ethoxylated bisphenol A diacrylate (2 mol of EO added). Then, a thermosensitive recording medium was obtained in the same manner as in Example 19 described above, except that the prepared [oil phase A] liquid and [oil phase B] liquid were used.

### Example 25

An [oil phase A] liquid and an [oil phase B] liquid were prepared in the same manner as in Example 19 described above, except that 5 parts of the composition containing a methacrylate copolymer and 42 parts of the ethoxylated bisphenol A diacrylate (2 mol of EO added) were used as the radical polymerizable compound. A product under the trade name of “VANARESIN GH-9903” (manufactured by Shin-Nakamura Chemical Co., Ltd.) was used as the composition containing a methacrylate copolymer. A product under the trade name of “A-BPE-2” (manufactured by Shin-Nakamura Chemical Co., Ltd.) was used as the ethoxylated bisphenol A diacrylate (2 mol of EO added). Then, a thermosensitive recording medium was obtained in the same manner as in Example 19 described above, except that the prepared [oil phase A] liquid and [oil phase B] liquid were used.

### Example 26

An [oil phase A] liquid and an [oil phase B] liquid were prepared in the same manner as in Example 19 described above, except that 2 parts of the composition containing a methacrylate copolymer and 45 parts of the ethoxylated bisphenol A diacrylate (2 mol of EO added) were used as the radical polymerizable compound. A product under the trade name of “VANARESIN GH-9903” (manufactured by Shin-Nakamura Chemical Co., Ltd.) was used as the composition containing a methacrylate copolymer. A product under the trade name of “A-BPE-2” (manufactured by Shin-Nakamura Chemical Co., Ltd.) was used as the ethoxylated bisphenol A diacrylate (2 mol of EO added). Then, a thermosensitive recording medium was obtained in the same manner as in Example 19 described above, except that the prepared [oil phase A] liquid and [oil phase B] liquid were used.

### Example 27

An [oil phase A] liquid and an [oil phase B] liquid were prepared in the same manner as in Example 19 described above, except that ethoxylated bisphenol A diacrylate (2 mol of EO added) (A-BPE-2, manufactured by Shin-Nakamura Chemical Co., Ltd.) was used as the radical polymerizable compound. Then, a thermosensitive recording medium was obtained in the same manner as in Example 19 described above, except that the prepared [oil phase A] liquid and [oil phase B] liquid were used.

### Example 28

An [oil phase A] liquid and an [oil phase B] liquid were prepared in the same manner as in Example 19 described above, except that tris(2-hydroxyethyl)isocyanurate triacrylate (SR368, manufactured by Tomoe Engineering Co., Ltd.) was used as the radical polymerizable compound. Then, a thermosensitive recording medium was obtained in the same manner as in Example 19 described above, except that the prepared [oil phase A] liquid and [oil phase B] liquid were used.

### Example 29

A [water phase C] liquid was prepared in the same manner as in Example 19 described above, except that the amount of sodium di-2-ethylhexyl sulfosuccinate was changed to 4.0 parts and the amount of sodium polyacrylate was changed to 4.0 parts. Then, a thermosensitive recording medium was obtained in the same manner as in Example 19 described above, except that the prepared [water phase C] liquid was used. The particle size (D50) of the particles in the electron-donating dye precursor-containing particle dispersion liquid prepared using the [water phase C] liquid was 40 nm, and the particle size (D50) of the particles in the electron-accepting compound-containing particle dispersion liquid was 40 nm.

### Example 30

A [water phase C] liquid was prepared in the same manner as in Example 19 described above, except that the amount of sodium di-2-ethylhexyl sulfosuccinate was changed to 0.35 parts and the amount of sodium polyacrylate was changed to 0.35 parts. Then, a thermosensitive recording medium was obtained in the same manner as in Example 19 described above, except that the prepared [water phase C] liquid was used. The particle size (D50) of the particles in the electron-donating dye precursor-containing particle dispersion liquid prepared using the [water phase C] liquid was 500 nm, and the particle size (D50) of the particles in the electron-accepting compound-containing particle dispersion liquid was 520 nm.

### Example 31

A [water phase C] liquid was prepared in the same manner as in Example 19 described above, except that the amount of sodium di-2-ethylhexyl sulfosuccinate was changed to 4.0 parts and the amount of sodium polyacrylate was changed to 4.0 parts. In addition, an [oil phase A] liquid and an [oil phase B] liquid were prepared in the same manner as in Example 19 described above, except that the amount of ethyl acetate was changed to 480 parts. Then, a thermosensitive recording medium was obtained in the same manner as in Example 19 described above, except that the prepared [oil phase A] liquid, [oil phase B] liquid and [water phase C] liquid were used. The particle size (D50) of the particles in the electron-donating dye precursor-containing particle dispersion liquid was 9 nm, and the particle size (D50) of the particles in the electron-accepting compound-containing particle dispersion liquid was 8 nm.

### Example 32

A [water phase C] liquid was prepared in the same manner as in Example 19 described above, except that the amount of sodium di-2-ethylhexyl sulfosuccinate was changed to 0.1 parts and the amount of sodium polyacrylate was changed to 0.1 parts. Then, a thermosensitive recording medium was obtained in the same manner as in Example 19 described above, except that the prepared [water phase C] liquid was used. The particle size (D50) of the particles in the electron-donating dye precursor-containing particle dispersion liquid prepared using the [water phase C] liquid was 1,200 nm, and the particle size (D50) of the particles in the electron-accepting compound-containing particle dispersion liquid was 1,300 nm.

### Example 33

The following materials were mixed and dissolved to prepare an [oil phase D] liquid, a [water phase C] liquid and a liquid [E], respectively.

[Oil phase D] liquid: composition containing an electron-donating dye
precursor

| | |
|---|---|
| 3 -(1-ethyl-2-methylindol-3-yl)-3 -(4-diethyl amino-2-methylphenyl)-4-azaphthalide | 40 parts |
| (BLUE220, manufactured by Fukui Yamada Chemical Co., Ltd.) | |
| tris(2-hydroxyethyl)isocyanurate triacrylate | 47 parts |
| (SR368, manufactured by Tomoe Engineering Co., Ltd.) | |
| Photopolymerization initiator (Omnirad TPO, manufactured by IGM Resin | 13 parts |
| Corporation) | |
| Ethyl acetate | 120 parts |

[Water phase C] liquid

| | |
|---|---|
| Polyvinyl alcohol (KURARAY POVAL 5-88, manufactured by Kuraray Co., Ltd.) | 2.5 parts |
| Sodium di-2-ethylhexyl sulfosuccinate | 1.0 part |
| Sodium polyacrylate (ARON T-50, manufactured by Toagosei Co., Ltd.) | 1.0 part |
| Boric acid | 0.02 parts |
| Sodium tetraborate decahydrate | 0.02 parts |
| Water | 95.5 parts |

Liquid [E]: composition containing an electron-accepting compound

| | |
|---|---|
| 2,2′-diallyl-4,4′-sulfonyldiphenol | 40 parts |
| (TGSH (H), manufactured by Nippon Kayaku Co., Ltd.) | |
| Polyvinyl alcohol (KURARAY POVAL 5-88, manufactured | 2.5 parts |
| by Kuraray Co., Ltd.) | |
| Water | 20 parts |

[Preparation of Electron-Donating Dye Precursor-Containing Particle Dispersion Liquid]

80 parts of the [oil phase D] liquid and 100 parts of the [water phase C] liquid were mixed, and then emulsified using an ultrasonic homogenizer (UH-600S, manufactured by SMT Co., Ltd.). Then, the ethyl acetate was removed under reduced pressure using a rotary evaporator to obtain an electron-donating dye precursor-containing particle dispersion liquid. The particle size (D50) of the particles in the electron-donating dye precursor-containing particle dispersion liquid, which was measured using a particle size distribution analyzer (NANOTRAC, manufactured by MicrotracBEL Corp.), was 150 nm.

[Preparation of Electron-Accepting Compound-Containing Particle Dispersion Liquid]

The liquid [E] was pulverized and dispersed using a bead mill to obtain an electron-accepting compound-containing particle dispersion liquid. The particle size (D50) of the particles in the electron-accepting compound-containing particle dispersion liquid, which was measured using a particle size distribution analyzer (NANOTRAC, manufactured by MicrotracBEL Corp.), was 1.5

[Formation of Thermosensitive Coloring Layer]

10 parts of the electron-donating dye precursor-containing particle dispersion liquid and 10 parts of the electron-accepting compound-containing particle dispersion liquid were mixed, and then the mixture was applied onto a synthetic paper (YUPO, manufactured by Yupo Corporation) having a thickness of 130 μm such that the coating amount after drying was 8.45 g/m². This was followed by drying to form a thermosensitive coloring layer. The coating amount of BLUE220 was 0.20 g/m², and the coating amount of TGSH (H) was 1.00 g/m².

[Preparation of Kaolin Dispersion Liquid (Liquid C)]

Using Kolese, 59.5 parts of kaolin, 0.5 parts of dispersant and 40 parts of water were dispersed for 1 hour to obtain a kaolin dispersion liquid (liquid C). A product under the trade name of “HYDRAGLOSS 90” (manufactured by KaMin LLC) was used as the kaolin. A product under the trade name of “ARON T-50” (solid content concentration: 40%, manufactured by Toagosei Co., Ltd.) was used as the dispersant.

[Formation of Protective Layer]

210 parts of a 10% aqueous solution of acetoacetyl-modified polyvinyl alcohol A, 80 parts of a 20% aqueous solution of acetoacetyl-modified polyvinyl alcohol B, 100 parts of liquid C, 5.6 parts of an aqueous dispersion of zinc stearate and 2.5 parts of a polyethylene wax emulsion were prepared. These components were mixed and stirred to obtain a coating liquid for a protective layer. A product under the trade name of “GOHSEFIMER Z-200” (saponification degree: 99.4 mol %, average degree of polymerization: 1,000, modification degree: 5 mol %, manufactured by Nihon Gosei Kako Co., Ltd.) was used as the acetoacetyl-modified polyvinyl alcohol A. A product under the trade name of “GOHSEFIMER Z-100” (saponification degree: 99.4 mol %, average degree of polymerization: 500, modification degree: 5 mol %, manufactured by Nihon Gosei Kako Co., Ltd.) was used as the acetoacetyl-modified polyvinyl alcohol B. A product under the trade name of “HIDORIN Z-8-36” (solid content concentration: 36%, manufactured by Chukyo Yushi Co., Ltd.) was used as the aqueous dispersion of zinc stearate. A product under the trade name of “CHEMIPEARL W-400” (solid content concentration: 40%, manufactured by Mitsui Chemicals, Inc.) was used as the polyethylene wax emulsion.

The obtained coating liquid for a protective layer was applied and dried onto the thermosensitive coloring layer such that the coating amount after drying was 1.5 g/m² to form a protective layer. Then, the surface of the formed layer was smoothed with a super calendar to obtain a thermosensitive recording medium.

### Example 34

An [oil phase D] liquid was prepared in the same manner as in Example 33 described above, except that a product under the trade name of “Omnirad 184” (manufactured by IGM Resin Corporation) was used as the photopolymerization initiator. Then, a thermosensitive recording medium was obtained in the same manner as in Example 33 described above, except that the prepared [oil phase D] liquid was used.

### Example 35

3,3-bis(1-n-butyl-2)-methylindol-3-yl) phthalide (RED-40, manufactured by Yamamoto Chemicals, Inc.) was used instead of 3-(1-ethyl-2-methylindol-3-yl)-3-(4-diethylamino-2-methylphenyl)-4-azaphthalide. Except for this, an [oil phase D] liquid was prepared in the same manner as in Example 33 described above. Then, a thermosensitive recording medium was obtained in the same manner as in Example 33 described above, except that the prepared [oil phase D] liquid was used.

### Example 36

A liquid [E] was prepared in the same manner as in Example 33 described above, except that 2,4′-dihydroxydiphenylsulfone (24BPS, manufactured by Nicca Chemical Co., Ltd.) was used instead of 2,2′-diaryl-4,4′-sulfonyldiphenol. Then, a thermosensitive recording medium was obtained in the same manner as in Example 33 described above, except that the prepared liquid [E] was used.

### Example 37

An [oil phase D] liquid was prepared in the same manner as in Example 33 described above, except that a product under the trade name of “Omnirad 184” (manufactured by IGM Resin Corporation) was used as the photopolymerization initiator. In addition, a liquid [E] was prepared in the same manner as in Example 33 described above, except that 2,4′-dihydroxydiphenylsulfone (24BPS, manufactured by Nicca Chemical Co., Ltd.) was used instead of 2,2′-diaryl-4,4′-sulfonyldiphenol. Then, a thermosensitive recording medium was obtained in the same manner as in Example 33 described above, except that the prepared [oil phase D] liquid and liquid [E] were used.

### Example 38

3-(1-ethyl-2-methylindol-3-yl)-3-(4-diethylamino-2-methylphenyl)-4-azaphthalide (BLUE220, manufactured by Fukui Yamada Chemical Co., Ltd.) was used instead of 3-diethylamino-7-(o-fluoroanilino)fluoran. Except for this, a liquid [A] was prepared in the same manner as in Example 1 described above. Then, a thermosensitive recording medium was obtained in the same manner as in Example 1 described above, except that the prepared liquid [A] was used.

### Example 39

Tris(2-hydroxyethyl)isocyanurate triacrylate (SR368, manufactured by Tomoe Engineering Co., Ltd.) was used as the radical polymerizable compound, and a product under the trade name of “Omnirad 369” (manufactured by IGM Resin Corporation) was used as the photopolymerization initiator. Except for this, an [oil phase A] liquid and an [oil phase B] liquid were prepared in the same manner as in Example 19 described above. Then, a thermosensitive recording medium was obtained in the same manner as in Example 19 described above, except that the prepared [oil phase A] liquid and [oil phase B] liquid were used.

### Example 40

Tris(2-hydroxyethyl)isocyanurate triacrylate (SR368, manufactured by Tomoe Engineering Co., Ltd.) was used as the radical polymerizable compound, and a product under the trade name of “Omnirad 907” (manufactured by IGM Resin Corporation) was used as the photopolymerization initiator. Except for this, an [oil phase A] liquid and an [oil phase B] liquid were prepared in the same manner as in Example 19 described above. Then, a thermosensitive recording medium was obtained in the same manner as in Example 19 described above, except that the prepared [oil phase A] liquid and [oil phase B] liquid were used.

### Example 41

Tris(2-hydroxyethyl)isocyanurate triacrylate (SR368, manufactured by Tomoe Engineering Co., Ltd.) was used as the radical polymerizable compound, and a product under the trade name of “Kayacure DETX-S” (manufactured by Nippon Kayaku Co., Ltd.) was used as the photopolymerization initiator. Except for this, an [oil phase A] liquid and an [oil phase B] liquid were prepared in the same manner as in Example 19 described above. Then, a thermosensitive recording medium was obtained in the same manner as in Example 19 described above, except that the prepared [oil phase A] liquid and [oil phase B] liquid were used.

### Example 42

Tris(2-hydroxyethyl)isocyanurate triacrylate (SR368, manufactured by Tomoe Engineering Co., Ltd.) was used as the radical polymerizable compound, and a product under the trade name of “Omnirad EMK” (manufactured by IGM Resin Corporation) was used as the photopolymerization initiator. Except for this, an [oil phase A] liquid and an [oil phase B] liquid were prepared in the same manner as in Example 19 described above. Then, a thermosensitive recording medium was obtained in the same manner as in Example 19 described above, except that the prepared [oil phase A] liquid and [oil phase B] liquid were used.

### Example 43

Tris(2-hydroxyethyl)isocyanurate triacrylate (SR368, manufactured by Tomoe Engineering Co., Ltd.) was used as the radical polymerizable compound, and a product under the trade name of “Omnirad BMS” (manufactured by IGM Resin Corporation) was used as the photopolymerization initiator. Except for this, an [oil phase A] liquid and an [oil phase B] liquid were prepared in the same manner as in Example 19 described above. Then, a thermosensitive recording medium was obtained in the same manner as in Example 19 described above, except that the prepared [oil phase A] liquid and [oil phase B] liquid were used.

### Example 44

Tris(2-hydroxyethyl)isocyanurate triacrylate (SR368, manufactured by Tomoe Engineering Co., Ltd.) was used as the radical polymerizable compound, and a product under the trade name of “Omnirad 819” (manufactured by IGM Resin Corporation) was used as the photopolymerization initiator. Except for this, an [oil phase A] liquid and an [oil phase B] liquid were prepared in the same manner as in Example 19 described above. Then, a thermosensitive recording medium was obtained in the same manner as in Example 19 described above, except that the prepared [oil phase A] liquid and [oil phase B] liquid were used.

### Comparative Example 7

An [oil phase A] liquid and an [oil phase B] liquid were prepared in the same manner as in Example 19 described above, except that hexanediol diacrylate (HDDA, manufactured by BASF SE) was used as the radical polymerizable compound. Then, a thermosensitive recording medium was obtained in the same manner as in Example 19 described above, except that the prepared [oil phase A] liquid and [oil phase B] liquid were used.

### Comparative Example 8

An [oil phase A] liquid and an [oil phase B] liquid were prepared in the same manner as in Example 19 described above, except that EO-modified hexanediol diacrylate (MIRAMER M202, manufactured by Miwon Specialty Chemical Co., Ltd., repeating number n of oxyethylene group: 2) was used as the radical polymerizable compound. Then, a thermosensitive recording medium was obtained in the same manner as in Example 19 described above, except that the prepared [oil phase A] liquid and [oil phase B] liquid were used.

### Comparative Example 9

An [oil phase A] liquid and an [oil phase B] liquid were prepared in the same manner as in Example 19 described above, except that PO-modified hexanediol diacrylate (PHOTOMER 4362, manufactured by Cognis Corporation, repeating number n of oxypropylene group: 2) was used as the radical polymerizable compound. Then, a thermosensitive recording medium was obtained in the same manner as in Example 19 described above, except that the prepared [oil phase A] liquid and [oil phase B] liquid were used.

### Comparative Example 10

An [oil phase A] liquid and an [oil phase B] liquid were prepared in the same manner as in Example 19 described above, except that dipentaerythritol hexaacrylate (A-DPH, manufactured by Shin-Nakamura Chemical Co., Ltd.) was used as the radical polymerizable compound. Then, a thermosensitive recording medium was obtained in the same manner as in Example 19 described above, except that the prepared [oil phase A] liquid and [oil phase B] liquid were used.

### Comparative Example 11

A mixture of 1-methylpropylphenylphenylmethane and 1-(1-methylpropylphenyl)-2-phenylethane (NISSEKI HISOL SAS-310, manufactured by Nippon Petrochemicals Co., Ltd.) was used as the radical polymerizable compound and the photopolymerization initiator. Except for this, an [oil phase A] liquid and an [oil phase B] liquid were prepared in the same manner as in Example 19 described above. Then, a thermosensitive recording medium was obtained in the same manner as in Example 19 described above, except that the prepared [oil phase A] liquid and [oil phase B] liquid were used.

<Evaluation (2)>

(Storage Stability)

Using a reflection densitometer (trade name: “Xrite530”, manufactured by Sakata Inx Corporation), the optical reflection density of the thermosensitive recording medium before storage (on the day of production), after storage in an incubator at 50° C. for 1 month and after storage in an incubator at 50° C. for 3 months was measured. The results are shown in Table 2.

(Color Development Property)

Using a thermal head (KPE model series, manufactured by Kyocera Corporation), the application electric power and the pulse width were set such that the recording energy per unit area was 90 mJ/mm², 120 mJ/mm² and 150 mJ/mm², and an image of 2 cm×2 cm was formed on the thermosensitive recording medium. The optical reflection density of the formed image was measured using a reflection densitometer (trade name: “Xrite530”, manufactured by Sakata Inx Corporation). The results are shown in Table 2.

TABLE 2

| | Radical polymerizable compound | | | | | | | | |
|---|---|---|---|---|---|---|---|---|---|
| | | (weight | | Storability | | | Color developability | | |
| | Melting | average) | Glass | (optical reflection density) | | | (optical reflection density) | | |
| | point | Molecular | transition | Before | 50° C. | 50° C. | 90 | 120 | 150 |
| | (° C.) | weight | point (° C.) | storage | 1 month | 3 months | mJ/mm² | mJ/mm² | mJ/mm² |
| Example 19 | 63 | 40,000 | 53 | 0.06 | 0.07 | 0.12 | 0.68 | 1.48 | 1.87 |
| Example 20 | ≥60 | 10,500 | 63 | 0.06 | 0.08 | 0.13 | 0.65 | 1.45 | 1.82 |
| Example 21 | ≥60 | 100,000 | 110 | 0.06 | 0.08 | 0.15 | 0.64 | 1.46 | 1.85 |
| Example 22 | ≥60 | 13,000 | 41 | 0.06 | 0.07 | 0.14 | 0.62 | 1.46 | 1.82 |
| Example 23 | 63 | 5,462 | ≤30 | 0.06 | 0.07 | 0.20 | 0.63 | 1.47 | 1.86 |
| Example 24 | 63 | 3,446 | ≤30 | 0.06 | 0.08 | 0.21 | 0.63 | 1.46 | 1.85 |
| Example 25 | 63 | 1,431 | ≤30 | 0.06 | 0.08 | 0.22 | 0.62 | 1.45 | 1.86 |
| Example 26 | 63 | 927 | ≤30 | 0.06 | 0.08 | 0.25 | 0.62 | 1.48 | 1.86 |
| Example 27 | 63 | 423 | ≤30 | 0.06 | 0.07 | 0.27 | 0.61 | 1.46 | 1.87 |
| Example 28 | 53 | 425 | ≤30 | 0.06 | 0.09 | 0.29 | 0.61 | 1.47 | 1.88 |
| Example 29 | 53 | 425 | ≤30 | 0.06 | 0.08 | 0.33 | 0.62 | 1.45 | 1.86 |
| Example 30 | 53 | 425 | ≤30 | 0.06 | 0.07 | 0.29 | 0.59 | 1.41 | 1.80 |
| Example 31 | 53 | 425 | ≤30 | 0.06 | 0.08 | 0.37 | 0.61 | 1.47 | 1.87 |
| Example 32 | 53 | 425 | ≤30 | 0.06 | 0.08 | 0.29 | 0.57 | 1.38 | 1.70 |
| Example 33 | 53 | 425 | ≤30 | 0.06 | 0.08 | 0.40 | 0.43 | 1.16 | 1.58 |
| Example 34 | 53 | 425 | ≤30 | 0.06 | 0.08 | 0.39 | 0.41 | 1.15 | 1.58 |
| Example 35 | 53 | 425 | ≤30 | 0.06 | 0.07 | 0.42 | 0.43 | 1.20 | 1.51 |
| Example 36 | 53 | 425 | ≤30 | 0.06 | 0.07 | 0.40 | 0.41 | 1.16 | 1.57 |
| Example 37 | 53 | 425 | ≤30 | 0.06 | 0.07 | 0.41 | 0.42 | 1.15 | 1.57 |
| Example 38 | 53 | 425 | ≤30 | 0.06 | 0.08 | 0.42 | 0.22 | 0.94 | 1.49 |
| Example 39 | 53 | 425 | ≤30 | 0.06 | 0.09 | 0.28 | 0.61 | 1.47 | 1.89 |
| Example 40 | 53 | 425 | ≤30 | 0.06 | 0.09 | 0.29 | 0.60 | 1.47 | 1.87 |
| Example 41 | 53 | 425 | ≤30 | 0.06 | 0.08 | 0.28 | 0.62 | 1.48 | 1.88 |
| Example 42 | 53 | 425 | ≤30 | 0.06 | 0.07 | 0.29 | 0.59 | 1.48 | 1.89 |
| Example 43 | 53 | 425 | ≤30 | 0.06 | 0.09 | 0.28 | 0.61 | 1.47 | 1.88 |
| Example 44 | 53 | 425 | ≤30 | 0.06 | 0.09 | 0.28 | 0.61 | 1.47 | 1.88 |
| Comparative | 7 | 226 | ≤0 | 0.13 | 0.48 | 1.07 | 0.38 | 1.12 | 1.55 |
| Example 7 | | | | | | | | | |
| Comparative | ≤0 | 314 | ≤0 | 0.14 | 0.42 | 1.05 | 0.39 | 1.15 | 1.53 |
| Example 8 | | | | | | | | | |
| Comparative | ≤0 | 342 | ≤0 | 0.13 | 0.45 | 1.03 | 0.39 | 1.09 | 1.54 |
| Example 9 | | | | | | | | | |
| Comparative | ≤0 | 579 | ≤0 | 0.13 | 0.43 | 1.05 | 0.37 | 1.14 | 1.53 |
| Example 10 | | | | | | | | | |
| Comparative | ≤0 | — | ≤0 | 0.28 | 0.53 | 1.16 | 0.44 | 1.18 | 1.59 |
| Example 11 | | | | | | | | | |

As shown in Table 2, upon comparing the results of Example 38 and Example 37, it can be seen that the color development property of the image is greatly improved in a case where the thermosensitive coloring layer contains particles containing an electron-donating dye precursor, a radical polymerizable compound and a photoradical polymerization initiator. In addition, upon comparing the results of Example 33 with the results of Examples 31 and 32, it can be seen that the color development property of the image is greatly improved in a case where the thermosensitive coloring layer contains particles containing an electron-accepting compound, a radical polymerizable compound and a photoradical polymerization initiator.

Upon comparing the results of Examples 31 and 32 with the results of Examples 29 and 30, it can be seen that both color development property and storage stability of the image can be achieved in a case where the particle size of the particles in the thermosensitive coloring layer was set to 10 nm or more to 1,000 nm or less. In addition, upon comparing the results of Examples 29 and 30 with the results of Example 28, it can be seen that both color development property and storage stability of the image can be achieved at a higher level in a case where the particle size of the particles in the thermosensitive coloring layer was set to 50 nm or more to 300 nm or less.

Upon comparing the results of Example 28 and Example 27, it can be seen that the color development property of the image is not deteriorated and the storage stability is improved in a case where the melting point of the radical polymerizable compound is 60° C. or higher. In addition, upon comparing the results of Example 27 and Example 26, it can be seen that the color development property of the image is not deteriorated and the storage stability is improved in a case where the molecular weight of the radical polymerizable compound is 1,000 or more.

Upon comparing the results of Example 26 with the results of Examples 23, 24 and 25, it can be seen that the color development property of the image is not deteriorated and the storage stability is improved in a case where the molecular weight of the radical polymerizable compound is 1,000 or more.

Upon comparing the results of Examples 24 and 25 with the results of Examples 20 and 23, it can be seen that the color development property of the image is not deteriorated and the storage stability is improved in a case where the glass transition point of the radical polymerizable compound is 40° C. or higher. Furthermore, it can be seen that the thermosensitive recording bodies of Comparative Examples 7 to 10 showed significant fogging occurred due to storage, since a radical polymerizable compound that was liquid at 25° C. was used.

An image was formed on the thermosensitive recording medium of each of Examples 19 to 44 and Comparative Examples 7 to 11 under the same conditions as in the above-mentioned evaluation of “color development property”. Then, using an ultraviolet irradiation device (ME12-L61, manufactured by Eye Graphics Co., Ltd.) equipped with a metal halide lamp (120 W/cm), the thermosensitive recording medium was irradiated with ultraviolet rays three times at a conveyor speed of 100 m/min. As a result, it was confirmed that the thermosensitive recording bodies of Examples 19 to 44 and Comparative Examples 7 to 10 showed no occurrence of fogging and no change in the color development property of the image. Furthermore, it was confirmed that any of the thermosensitive recording bodies showed no occurrence of fogging and no change in the color development property of the image even in a case of being stored at 50° C. for 3 months after the image was formed. On the other hand, the thermosensitive recording medium of Comparative Example 11 could not obtain the effect of ultraviolet irradiation, and showed significant occurrence of fogging after storage at 50° C. for 3 months.

<Formation and Evaluation of Image>

### Example 45

Using a thermal head (KPE model series, manufactured by Kyocera Corporation), a recording energy of 90 mJ/mm² per unit area was applied to the thermosensitive recording medium of Example 38 to develop a color. Next, using an ultraviolet irradiation device (ME12-L61, manufactured by Eye Graphics Co., Ltd.) equipped with a metal halide lamp (120 W/cm), the thermosensitive recording medium was irradiated with ultraviolet rays three times at a conveyor speed of 100 m/min. In addition, the thermosensitive recording medium of Example 38, which has been subjected to color development in the same manner, was irradiated with ultraviolet rays once at a conveyor speed of 10 m/min, using a 4 W/cm²UV-LED light source (4 types of wavelengths: 365 nm, 375 nm, 395 nm and 405 nm). After that, in a case where all the thermosensitive recording bodies were stored at 50° C. for 3 months, it was confirmed that any of the thermosensitive recording bodies showed no occurrence of fogging and no change in the color development property of the image.

### Example 46

Using a thermal head (KPE model series, manufactured by Kyocera Corporation), the application electric power and the pulse width were set such that the temperature of the heat pulse was set within a range of 80° C. or higher to 220° C. or lower, and an image was formed on the thermosensitive recording medium of Example 38. The formed image showed a smooth gradation with continuously changing optical densities.

According to the present invention, it is possible to provide a thermosensitive recording medium capable of forming an image having excellent color development property by suppressing the occurrence of defects that occur during storage before the formation of an image, such as fogging. Further, according to the present invention, it is possible to provide an image forming method using the above-mentioned thermosensitive recording medium.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A thermosensitive recording medium comprising a thermosensitive coloring layer containing an electron-donating dye precursor, an electron-accepting compound, a radical polymerizable compound and a photoradical polymerization initiator,
wherein the radical polymerizable compound is a compound that is solid at 25° C., and
the radical polymerizable compound is contained in the thermosensitive coloring layer in a state of encapsulating at least one of the electron-donating dye precursor and the electron-accepting compound.

2. The thermosensitive recording medium according to claim 1, wherein the radical polymerizable compound is contained in the thermosensitive coloring layer in a state of a first particle encapsulating the electron-donating dye precursor.

3. The thermosensitive recording medium according to claim 2, wherein the first particle has a particle size of 10 nm or more to 1,000 nm or less.

4. The thermosensitive recording medium according to claim 2, wherein the first particle has a particle size of 50 nm or more to 300 nm or less.

5. The thermosensitive recording medium according to claim 1, wherein the radical polymerizable compound is contained in the thermosensitive coloring layer in a state of a second particle encapsulating the electron-accepting compound.

6. The thermosensitive recording medium according to claim 5, wherein the second particle has a particle size of 10 nm or more to 1,000 nm or less.

7. The thermosensitive recording medium according to claim 5, wherein the second particle has a particle size of 50 nm or more to 300 nm or less.

8. The thermosensitive recording medium according to claim 1, wherein the radical polymerizable compound has a melting point of 60° C. or higher.

9. The thermosensitive recording medium according to claim 1, wherein the radical polymerizable compound has a weight average molecular weight of 1,000 or more.

10. The thermosensitive recording medium according to claim 1, wherein the radical polymerizable compound has a glass transition point of 40° C. or higher.

11. An image forming method comprising:
a step of forming an image by applying a heat pulse to a thermosensitive recording medium using a thermal head,
wherein the thermosensitive recording medium comprising a thermosensitive coloring layer containing an electron-donating dye precursor, an electron-accepting compound, a radical polymerizable compound and a photoradical polymerization initiator,
wherein the radical polymerizable compound is a compound that is solid at 25° C., and
the radical polymerizable compound is contained in the thermosensitive coloring layer in a state of encapsulating at least one of the electron-donating dye precursor and the electron-accepting compound; and
a step of irradiating the thermosensitive recording medium on which the image is formed with ultraviolet rays to fix the thermosensitive coloring layer.
